(19) United States
(12) Patent Application Publication
(10) Pub. No.: US 2016/0349746 A1
(43) Pub. Date: Dec. 1, 2016

(54) UNMANNED AERIAL VEHICLE HAVING A PROJECTOR AND BEING TRACKED BY A LASER TRACKER

(71) Applicant: FARO Technologies, Inc., Lake Mary, FL (US)

(72) Inventor: Markus Grau, Korntal-Muenchingen (DE)

(21) Appl. No.: 15/141,941

(22) Filed: Apr. 29, 2016

Related U.S. Application Data
(60) Provisional application No. 62/167,978, filed on May 29, 2015.

(51) Int. Cl. G05D 1/00; B64D 47/08; G05D 1/10; B64C 39/02

(52) U.S. Cl. CPC G05D 1/0011; B64C 39/024; B64D 47/08; G05D 1/0094; G05D 1/101; B64C 2201/123; B64C 2201/108

(57) ABSTRACT

An unmanned aerial vehicle (UAV) such as a drone, quadcopter or octocopter having a projector on board for projecting information into physical space such as onto objects or locations while the UAV is in flight, and further with the position and orientation (i.e., the six degrees of freedom) of the UAV in flight being accurately tracked and controlled from the ground, e.g., by a laser tracker or a camera bar, thereby leading to a relatively more stable flight of the UAV.

### CROSS REFERENCE TO RELATED APPLICATIONS

This application claims the benefit of U.S. Provisional Application Ser. No. 62/167,978, filed May 29, 2015, the entire disclosure of which is incorporated herein by reference.

### FIELD OF THE INVENTION

The present disclosure relates in general to unmanned aerial vehicles (UAVs), and more particularly to a UAV such as a drone, quadcopter or octocopter having a projector on board for projecting information into physical space such as onto objects or terrain locations while the UAV is in flight, and further with the position and orientation of the UAV in flight being accurately tracked and controlled from the ground, e.g., by a laser tracker or a camera bar.

### BACKGROUND OF THE INVENTION

Unmanned aerial vehicles (UAVs) such as drones, quadcopters or octocopters are rapidly becoming increasingly popular for use in both business and recreational activities and for various different purposes. These UAVs are relatively inexpensive, are easy to learn to fly (typically via remote control by a human operator), and can have one or more cameras (e.g., either for taking still pictures or videos) and/or other contactless optical imaging devices (e.g., a two-dimensional (2D) or three-dimensional (3D) scanner) mounted on board or carried by the UAV. A user can then review the pictures, videos or images either in real time as they are being taken or recorded or after the UAV has returned to the ground. This way the user can get an aerial view of the surface of the landscape or terrain (e.g., typically the ground and any objects thereon), or of a large object such as an aircraft or a building that the UAV was flown over, around, and/or through. From this aerial view the user can make determinations about the imaged objects or terrain, such as to assess the extent of any damage thereto or the condition thereof, or whether the objects have been built (or are being built) to within a permissible dimensional tolerance range. These UAVs are useful in that they can be used in flight either outdoors or indoors (e.g., within a manufacturing or assembly area within a building).

As mentioned, typically a UAV is flown under the control of a human operator by way of, e.g., a hand-held remote control. While this type of UAV flight pattern or path control is suitable for many usages of the UAV (most commonly recreational usages), typically this type of human control is not accurate enough for the situation in which the UAV carries an imaging device (e.g., a 3D laser scanner). Use of the imaging device is intended to capture large amounts of 3D data with respect to the surface of an object such as an aircraft or a building while the UAV is in flight. That is, in operation the 3D imaging device typically captures millions of data points with respect to the surface of an object in the form of a point cloud, and the point cloud data is subsequently processed to determine or provide a desired relatively accurate rendering of the 3D surface of the object such as the aircraft or building that the UAV was flown over, around, and/or through. However, controlling the flight path by way of a human-operated remote control most often inherently results in an unstable flight of the UAV, which necessarily leads to the result of incorrect point cloud data capturing and, thus, an incorrect 3D rendering of the object surface. Thus, it is desired to provide a relatively more accurate method and device for controlling the flight path of a UAV for various data capture purposes.

In addition, an unstable flight of the UAV also results in a less than desired accuracy in the projection of information onto an object by a projector that is carried by the UAV. This is because unstable UAV flight (e.g., rapid “jerking” UAV motion, UAV movement when hovering instead is desired, etc.) results in unstable positioning of the projector. The unstable UAV flight may result in an inability of a human on the ground or an imaging device on the UAV to properly read or view the projected information.

While existing UAVs may be suitable for some of their intended purposes, what is needed is a UAV that, while in flight, can project information onto an object for various purposes while at the same time allowing for the position and orientation (i.e., the six degrees of freedom (six-DOF)) of the UAV to be tracked more accurately by a device on the ground such as a laser tracker or a camera bar, thereby leading to more accurate control of the position and orientation of the UAV and, thus, to a relatively more stable flight of the UAV.

### SUMMARY OF THE INVENTION

According to one aspect of the invention, a system for determining three-dimensional (3D) information regarding a surface of an object and projecting information onto the object surface or onto another surface includes an unmanned aerial vehicle configured to fly in physical space in a flight path that is under the control of a control device, and aa scanning device located on the unmanned aerial vehicle, the scanning device configured to scan the object surface to measure two-dimensional (2D) or 3D coordinates thereof and to determine the 3D information of the object surface from the scanned 2D or 3D coordinates. The system also includes a projector located on the unmanned aerial vehicle, the projector configured to project the information in the form of visible light onto the object surface or onto the another surface, and a position tracking device at least a portion of which is located apart from the unmanned aerial vehicle, the position tracking device being configured to comprise at least a portion of the control device to control the flight path of the unmanned aerial vehicle in physical space by sensing a position and orientation of the unmanned aerial vehicle in physical space and controlling the flight path in response to the sensed position and orientation of the unmanned aerial vehicle in physical space.

These and other advantages and features will become more apparent from the following description taken in conjunction with the drawings.

### BRIEF DESCRIPTION OF THE DRAWINGS

Referring now to the drawings, exemplary embodiments are shown which should not be construed to be limiting regarding the entire scope of the disclosure, and wherein the elements are numbered alike in several FIGURES:

FIG. 1 is a perspective view of a laser tracker according to an embodiment of the present invention;

FIG. 2 is a perspective view of an aircraft having visible light information projected thereon by a projector mounted in an unmanned aerial vehicle whose position and orientation in flight is tracked by a laser tracker on the ground according to an embodiment of the present invention;

FIG. 3 is a perspective view of a building having visible light information projected thereon by a projector mounted in an unmanned aerial vehicle whose position and orientation in flight is tracked by a laser tracker on the ground according to an embodiment of the present invention;

FIG. 4 is a perspective view of a triangulation scanner according to an embodiment of the present invention;

FIG. 5 is a schematic illustration of the principle of operation of a triangulation scanner that emits a line of light according to an embodiment of the present invention;

FIGS. 6A and 6B are schematic illustrations of the principle of operation of a structured light triangulation scanner according to two embodiments of the present invention;

FIG. 7 is a block diagram of a laser tracker having six degrees of freedom (six-DOF) measurement capability and of elements in a six-DOF scanner according to an embodiment of the present invention;

FIG. 8 is a block diagram of elements in a laser tracker with six-DOF measurement capability according to an embodiment of the present invention;

FIG. 9 is a schematic diagram of elements of a six-DOF indicator according to an embodiment of the present invention;

FIG. 10 is a block diagram of a six-DOF projector according to an embodiment of the present invention;

FIG. 11 is a block diagram of a six-DOF projector according to an embodiment of the present invention;

FIG. 12 is a block diagram of a six-DOF sensor according to an embodiment of the present invention;

FIG. 13 is a block diagram of a six-DOF sensor according to an embodiment of the present invention; and

FIG. 14 is a perspective view of a camera bar used to measure the position and orientation of a triangulation area scanner having targets viewable by the camera bar according to an embodiment of the present invention.

The detailed description explains embodiments of the invention, together with advantages and features, by way of example with reference to the drawings.

### DETAILED DESCRIPTION

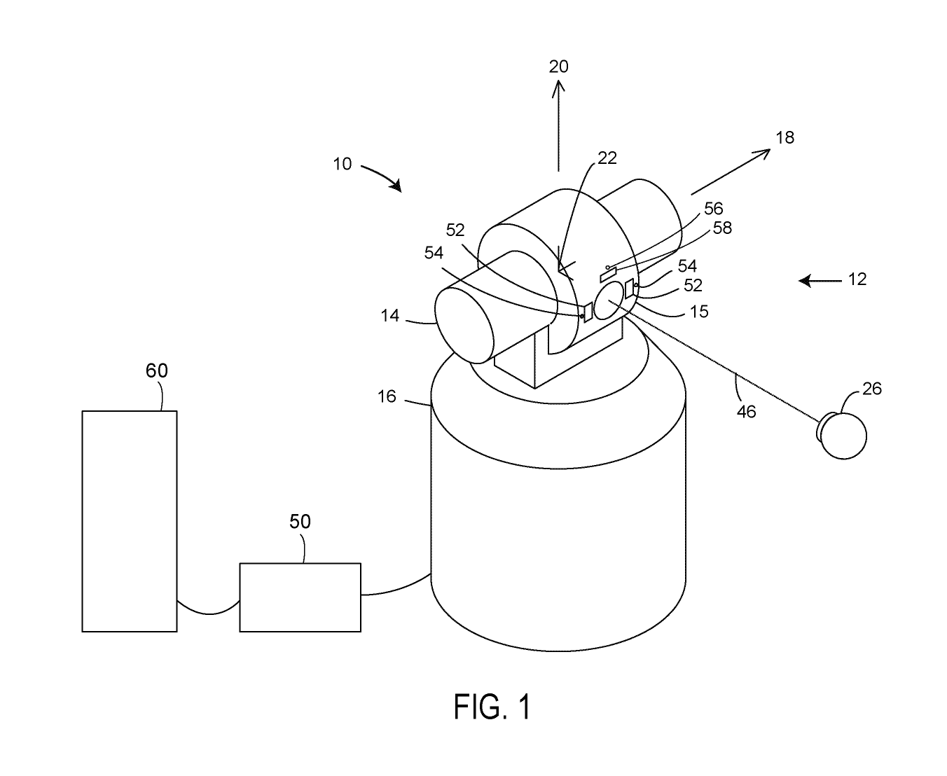

An exemplary laser tracker 10 is illustrated in FIG. 1. An exemplary gimbaled beam-steering mechanism 12 of laser tracker 10 includes zenith carriage 14 mounted on azimuth base 16 and rotated about azimuth axis 20. Payload 15 is mounted on zenith carriage 14 and rotated about zenith axis 18. Zenith mechanical rotation axis 18 and azimuth mechanical rotation axis 20 intersect orthogonally, internally to tracker 10, at gimbal point 22, which is typically the origin for distance measurements. Laser light beam 46 virtually passes through gimbal point 22 and is pointed orthogonal to zenith axis 18. In other words, laser beam 46 is in a plane normal to zenith axis 18. Laser beam 46 is pointed in the desired direction by motors within the tracker 10 that rotate payload 15 about zenith axis 18 and azimuth axis 20. Zenith and azimuth angular encoders, internal to the tracker 10, are attached to zenith mechanical axis 18 and azimuth mechanical axis 20 and indicate, to relatively high accuracy, the angles of rotation. Laser beam 46 travels to external retroreflector 26 such as a spherically mounted retroreflector (SMR), or other target type devices, as described in more detail hereinafter. By measuring the radial distance between gimbal point 22 and retroreflector 26 and the rotation angles about the zenith and azimuth axes 18, 20, the position of retroreflector 26 is found within the spherical coordinate system of the tracker.

Coordinate-measuring devices closely related to the laser tracker are the laser scanner and the total station. The laser scanner steps one or more laser beams to points on a surface. It picks up light scattered from the surface and from this light determines the distance and two angles to each point. The total station, which is most often used in surveying applications, may be used to measure the coordinates of diffusely scattering or retroreflective targets. Hereinafter, the term laser tracker is used in a broad sense to include laser scanners and total stations.

Laser beam 46 may include one or more laser wavelengths. For the sake of clarity and simplicity, a steering mechanism of the type shown in FIG. 1 is assumed in the following discussion. However, other types of steering mechanisms are possible. For example, it would be possible to reflect a laser beam off a mirror rotated about the azimuth and zenith axes. As another example, it would be possible to steer the laser beam by using two steering mirrors driven by actuators such as galvanometer motors. In this latter case, the laser beam could be steering without providing azimuth and zenith mechanical axes. The techniques described herein are applicable, regardless of the type of steering mechanism.

In exemplary laser tracker 10, cameras 52 and light sources 54 are located on payload 15. Light sources 54 illuminate one or more retroreflector targets 26. In an embodiment, light sources 54 are LEDs electrically driven to repetitively emit pulsed light. Each camera 52 includes a photosensitive array and a lens placed in front of the photosensitive array. The photosensitive array may be a CMOS or CCD array, for example. In an embodiment, the lens has a relatively wide field of view, for example, 30 or 40 degrees. The purpose of the lens is to form an image on the photosensitive array of objects within the field of view of the lens. Usually at least one light source 54 is placed near camera 52 so that light from light source 54 is reflected off each retroreflector target 26 onto camera 52. To illuminate a retroreflector target in a way that can be seen on the camera 52, the light source 54 is typically placed near the camera; otherwise the reflected light may be reflected at too large an angle and may miss the camera. In this way, retroreflector images are readily distinguished from the background on the photosensitive array as their image spots are brighter than background objects and are pulsed. In an embodiment, there are two cameras 52 and two light sources 54 placed about the line of laser beam 46. By using two cameras in this way, the principle of triangulation can be used to find the three-dimensional (3D) coordinates of any SMR or other target within the field of view of the camera. In addition, the 3D coordinates of an SMR or other target can be monitored as the SMR or target is moved from point to point. A use of two cameras for this purpose is described in U.S. Pat. No. 8,525,983 ('983) to Bridges et al., the contents of which are incorporated herein by reference.

Auxiliary unit 50 may be a part of laser tracker 10. The purpose of auxiliary unit 50 is to supply electrical power to the laser tracker body and in some cases to also supply computing and clocking capability to the system. It is possible to eliminate auxiliary unit 50 altogether by moving the functionality of auxiliary unit 50 into the tracker body. In most cases, auxiliary unit 50 is attached to general purpose computer 60. Application software loaded onto general purpose computer 60 may provide application capabilities such as reverse engineering. It is also possible to eliminate general purpose computer 60 by building its computing capability directly into laser tracker 10. In this case, a user interface, possibly providing keyboard and mouse functionality may be built into laser tracker 10. The connection between auxiliary unit 50 and computer 60 may be wireless or through a cable of electrical wires. Computer 60 may be connected to a network, and auxiliary unit 50 may also be connected to a network. Plural instruments, for example, multiple measurement instruments or actuators, may be connected together, either through computer 60 or auxiliary unit 50. In an embodiment, auxiliary unit 50 is omitted and connections are made directly between laser tracker 10 and computer 60.

In alternative embodiments of the present invention, the laser tracker 10 may utilize both wide field of view (FOV) and narrow FOV cameras 52 together on the laser tracker 10. For example, in an embodiment one of the cameras 52 in FIG. 1 is a narrow FOV camera and the other camera 52 is a wide FOV camera. With this arrangement, the wide FOV camera 52 identifies the retroreflective targets 26 over a relatively wider angular extent. The laser tracker 10 turns the laser beam 46 in the direction of a particular selected retroreflector target 26 until the retroreflector target 26 is within the FOV of the narrow FOV camera 52. The laser tracker 10 may then carry out a method for finding the location of a retroreflector target using images on the two cameras 52 mounted on the laser tracker 10. This is done to find the best estimate for the position of the retroreflector target 26. The method may be one as described in U.S. Pat. No. 8,619,265 ('265) to Steffey et al., the contents of which are incorporated herein by reference.

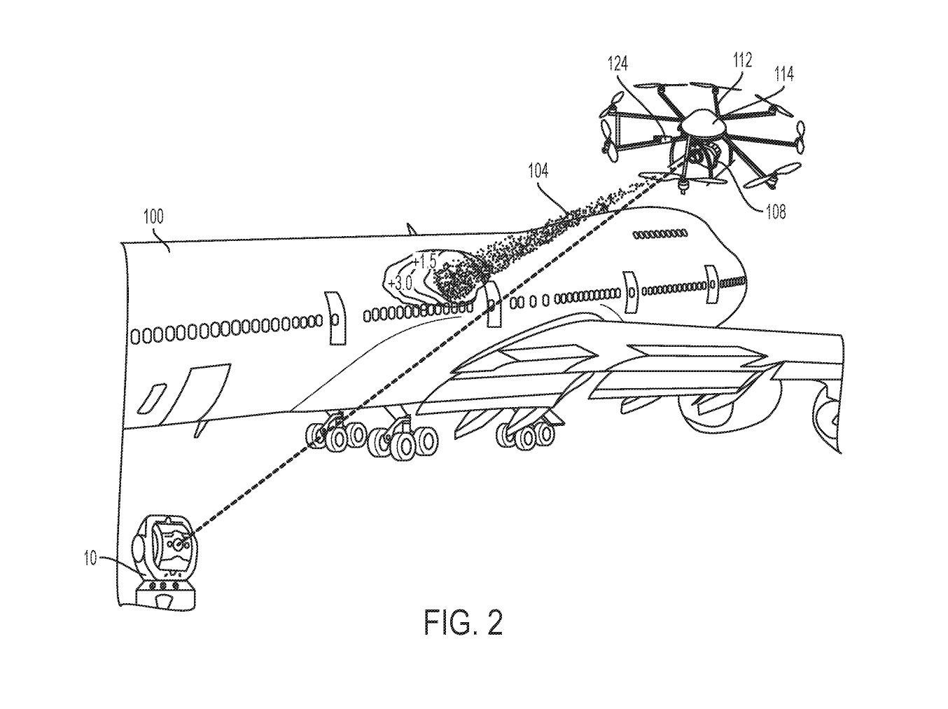

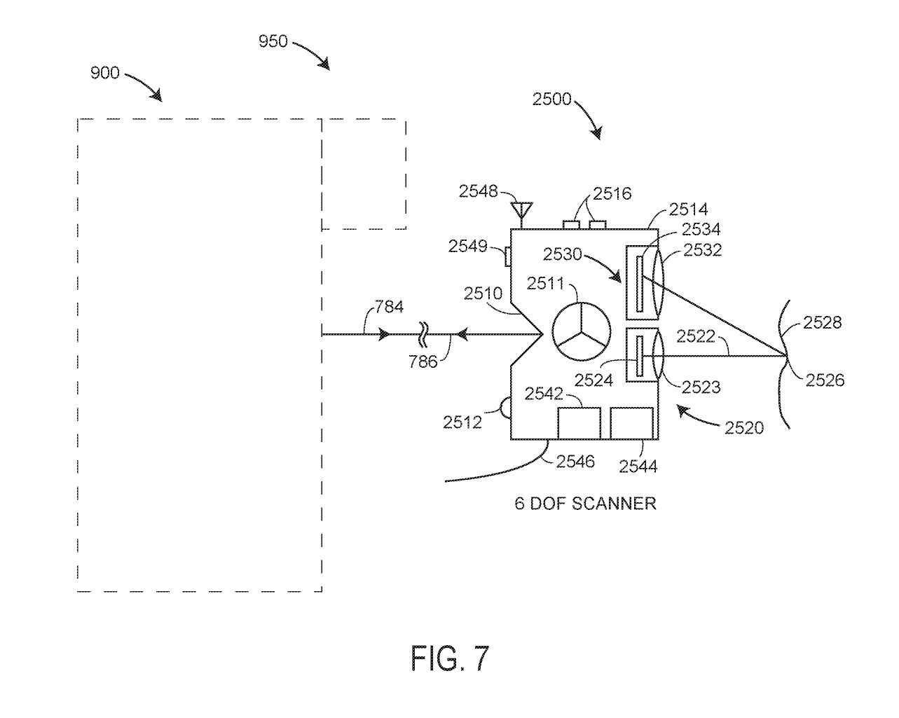

In another embodiment, both cameras 52 are wide FOV cameras and are used to locate the target and turn the laser beam 46 toward it. The two wide FOV cameras 52 determine the three-dimensional location of the retroreflector target 26 and turn the tracker light beam 46 toward the target 26. An orientation camera (not shown), similar to orientation camera 210 shown in FIGS. 2 and 7 of U.S. Pat. No. 7,800,758 ('758) to Bridges et al., which is incorporated herein by reference, views a small region around the illuminated retroreflector target 26. By observing the position of the retroreflector 26 in the photosensitive array of the orientation camera 210, the laser tracker 10 can immediately direct the laser beam 46 to the center of the retroreflector 26.

Laser trackers are available for measuring six, rather than the ordinary three, degrees of freedom (DOF) of a target type device. Exemplary six degree-of-freedom (six-DOF) systems are described in the aforementioned '758 patent and '983 patent—both to Bridges et al., along with U.S. Pat. No. 6,166,809 ('809) to Pettersen et al., and U.S. Published Patent Application No. 2010/0149525 ('525) to Lau, the contents of all of which are incorporated herein by reference. Six-DOF systems provide measurements of three orientational degrees of freedom (e.g., pitch, roll, yaw) as well as three positional degrees of freedom (i.e., x, y, z). Such 6-DOF measurements of various types of devices (e.g., targets, projectors, sensors, probes, etc.) are described in more detail hereinafter.

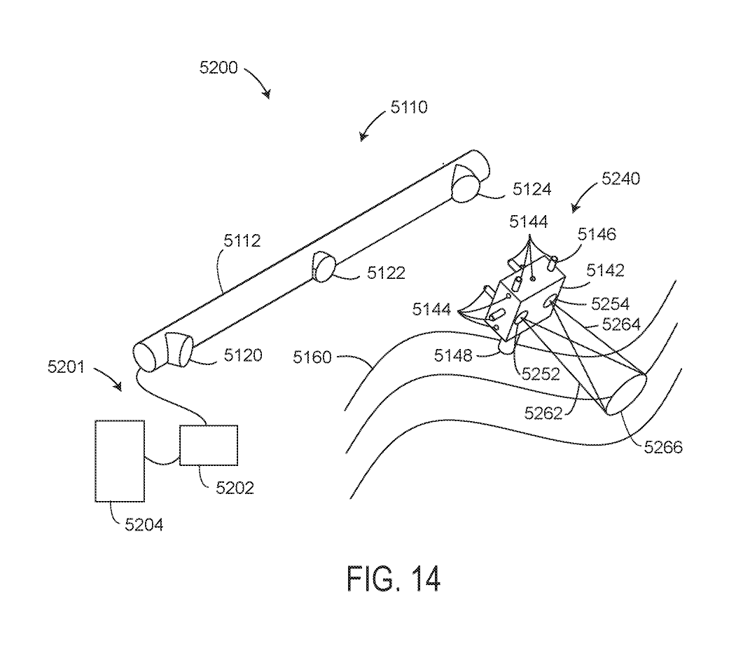

Referring to FIG. 2, there illustrated is a commercial passenger aircraft or airplane 100 having visible light information 104 projected on a fuselage portion by a projector 108 mounted on board or carried by an unmanned aerial vehicle (UAV) 112. As illustrated the UAV 112 may comprise an octocopter whose position and orientation in flight is tracked by a laser tracker 10 (FIG. 1) or camera bar (FIG. 14) located on the ground and utilizing any one of a number of types of six-DOF sensors 114 or other types of active or passive targets 114 mounted on or otherwise carried by the UAV 112, according to embodiments of the present invention and as described in detail hereinafter. The aircraft 100 may be located outdoors or indoors within a manufacturing or assembly area.

The UAV 112 may comprise a drone, a helicopter, a quadcopter (i.e., with four rotors), or an octocopter (i.e., with eight rotors), or some other type of unmanned aerial device (e.g., robot) or vehicle that is configured to fly in a pattern or path in a physical space (either outdoors or indoors), or to fly to specific positions in physical space, which can be controlled. Each rotor is typically driven by a motor or similar type of device.

The UAV 112 typically has located on board a computer or processor type of device that is configured (e.g., via software) as a guidance/navigation/flight control system for the UAV 112. For example, when used with a remote control operated by a human on the ground, the flight control system on the UAV 112 accepts commands communicated, e.g., wirelessly, from the remote control. These commands are typically indicative of a desired direction of movement of the UAV 112 within the physical space, or for hovering of the UAV 112 for some desired period of time in the approximate same position in physical space.

Embodiments of the present invention include projection of information as visible light 104 (e.g., in some form of a spot, line or other 2D pattern), by the projector 108 located on the UAV 112. The light 104 could be projected, for example, from a digital micromirror device (DMD) such as a digital light projector (DLP) from Texas Instruments, or a pico-projector provided by Microvision. The projector 108 may interact or communicate with the flight control system of the UAV 112 for control of information displayed by the projector 108. In the alternative, the projector 108 may have integrated therewith a processor and wireless communication capability. As such, the projector 108 may be able to communicate directly with devices on the ground (e.g., computers, measuring systems, etc.) and receive and process information to be projected therefrom. The projector 108 may be fixedly located on the UAV 112 or the projector 108 may be able to be moved along one or more axes of movement or rotation while located on the UAV 112. Such movement of the projector 108 may be carried out by motors or other drive devices that may be controlled by signals from the UAV's flight control system or from devices on the ground.

In embodiments of the present invention, the visible light information 104 is projected into physical space onto objects (e.g., aircraft, buildings) or locations (e.g., the physical terrain) while the UAV 112 is in flight—either while the UAV 112 is maneuvering (i.e., moving) or while the UAV 112 is holding relatively still in flight (i.e., hovering). Typically, however, the light information 104 projected is relatively more stable and, thus, more legible and easier to view when the UAV 112 is hovering. This allows for projection of light information 104 onto objects or locations that may otherwise be difficult to access for display and/or measurement purposes if not for the UAV 112 itself and with the UAV 112 carrying the projector 108 in flight.

An example of this is the relatively large aircraft 100 of FIG. 2 which is located in a large indoor area such as a manufacturing/assembly building, or outdoors, wherein the aircraft 100 is in the process of being manufactured and/or assembled, or inspected. The information 104 projected onto the aircraft 100 may comprise information indicative of the amount of deviation (e.g., in millimeters or inches) in a specific area of the aircraft (e.g., the fuselage, nose, tail, wings, etc.) between the actual manufactured aircraft itself at that location and the desired dimensions of the aircraft at that specific area. For example, FIG. 2 illustrates projected light information 104 that can be of different colors and include numbers superimposed within the information 104. The colors and the numbers (“+1.5,” “+3.0”) projected may indicate to the operator the amount of out of tolerance error in one or more dimensions of the aircraft. These out of tolerance errors may be due to a manufacturing error or may be due to an event that occurred after the aircraft 100 was placed in service. The actual dimensions of the specific area of the aircraft 100 that have light information 104 projected thereon may be obtained by a measuring system (e.g., a triangulation scanner) located on board the UAV 112, as discussed in more detail hereinafter.

In alternative embodiments, the information 104 projected onto the aircraft 100 may comprise information indicative of work needed at a particular location on the aircraft fuselage 100 (e.g., location(s) of holes drilled, paint or labels applied, material added or removed, etc.).

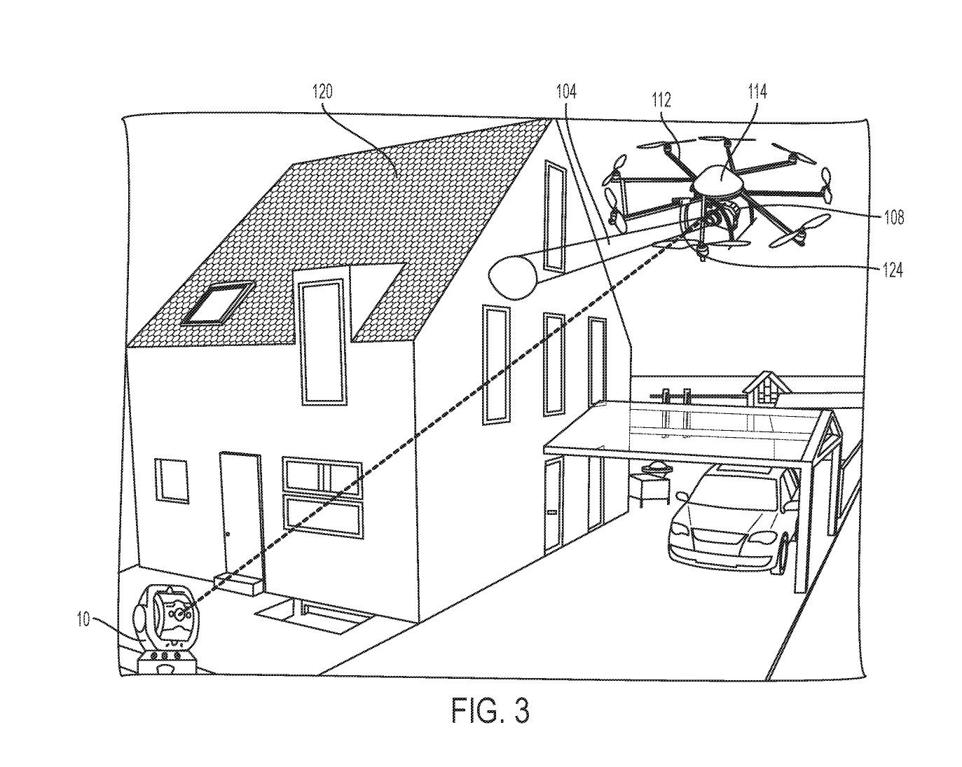

FIG. 3 illustrates another embodiment of the present invention in which a building 120 (e.g., a house) has visible light information 104 projected thereon by the projector 104 mounted in the UAV 112 whose position and orientation in flight is tracked by the laser tracker 10 on the ground. The projected information 104 in this embodiment may comprise an area of interest of the building 120 (e.g., an outside wall) for which certain work is to be performed.

In embodiments, the projector 108 may interact with humans who communicate information (e.g., messages) to the projector 108. For example, the projector 108 may project some type of background light information 104 (e.g., a pattern of one or more solid colors), and then may display over the background information text messages that are sent from humans via, e.g., smartphones, to the UAV 112. As such, the projector 108 is acting as a type of interactive display.

In other various embodiments of the present invention, the UAV 112 may be equipped on board with a two-dimensional (2D) or a three-dimensional (3D) measuring system 124. The measuring system 124 chosen depends in part on the relative complexity or density of the surface of the object or location (e.g., the physical terrain) desired to be scanned by the system. It is typically desired to capture the 3D characteristics of the surface of the object (e.g., the aircraft 100 or the building 120) as accurately as possible so that the resulting 3D rendering of the surface may replicate the actual surface as closely as possible. The measuring system 124 may comprise a triangulation-type scanner such as a line scanner (e.g., a laser line probe (LLP)), an area or pattern scanner (e.g., a structured light scanner), a time-of-flight (TOF) scanner, a 2D camera, and/or a 3D camera, and/or some other type of image capture device. The images captured by the measuring system 124 are typically registered together in some manner to obtain the resulting overall 3D information, for example, of the exterior or interior of a building 120 or of a surface of a relatively large object such as an aircraft 100.

In an embodiment, the laser scanner 124 may scan an object 100, 120 and then after processing the data, the UAV 112 may fly to areas of interest with respect to the object 100, 120 and illuminate those areas of the object with projected information 104 to assist an operator or user. Such projected information 104 might indicate a region of the measured object 100, 120 found to be dimensionally out of specification or an area in which an operator is to perform manufacturing or assembly operations such as drilling holes or attaching labels.

In another embodiment, the UAV 112 may determine its position in physical space in relation to the object-under-test 100, 120 in real-time and immediately project a pattern 104 in response. In an embodiment, the UAV measuring system 124 sends the collected information wirelessly to an external computer that identifies features on the object-under-test 100, 120 or at least the position of the UAV 112 in relation to the object-under-test 100, 120 and directs the UAV 112 to respond accordingly by taking some type of action.

In various other embodiments of the present invention, the flight pattern or path taken by the UAV 112, or the position and orientation in physical space of the UAV 112, while in flight is monitored or tracked by a device on the ground such as a laser tracker 10 or a camera bar. This may be accomplished by having the ground monitoring device 10 constantly track or follow the position and orientation (i.e., the six degrees of freedom (six-DOF)) of the UAV 112 during its flight. The laser tracker 10 (FIG. 1) or camera bar (FIG. 14) does this by tracking the position and orientation of a 6-DOF sensor 114 or other type of active or passive target 114 located on the UAV 112, as described in more detail hereinafter.

As described in conjunction with FIG. 1, a laser tracker 10 typically includes a distance measuring portion (i.e., a beam of light sent out from the laser tracker 10) which is used to determine the position location (e.g., the three positional coordinates—the x, y and z Cartesian coordinates) of the UAV 112 in physical space while in flight. In addition, the laser tracker 10 can use its one or more cameras 52 to determine the orientation location (e.g., the three orientational or rotational coordinates—the pitch, roll and yaw) of the UAV 112 in physical space while in flight. This is carried out by having the one or more cameras 52 of the laser tracker 10 record the position in physical space of one or more markers located on the UAV 112.

In the case of a 6-DOF laser tracker 10 used to determine the 6-DOF of the UAV 112 during flight, one or more 6-DOF sensors or targets 114 such as passive devices (e.g., retroreflectors or sphere targets) or active devices (e.g., light sources such as light emitting diodes (LEDs)) are mounted on the UAV 112 and placed and oriented with respect to one another in a known physical relationship. In the case of the camera bar instead of the laser tracker 10 used to determine the six-DOF of the UAV 112, and as described in more detail hereinafter with respect to FIG. 14, one or more light sources in the form of a 6-DOF illuminated point array may be placed on the UAV 112 itself or on a target device carried by the UAV 112. In the alternative, one or more reflective markers or sphere targets may be placed on the UAV 112 or on a target device carried by the UAV 112 and tracked by the camera bar to determine the position and orientation of the UAV 112 while in flight. The advantage of tracking the position and orientation (6-DOF) of the UAV 112 with a tracker or camera bar is that relatively much better accuracy of the position of the UAV 112 in physical space during flight can be obtained as opposed to requiring that the UAV 112 register its position and orientation based on natural features alone. This results in a relatively more stable flight of the UAV 112.

The UAV 112 itself may also contain one or more of various types of sensors on board for determining the position and/or orientation of the UAV 112 and, thus, of the measuring system 124 (i.e., the imaging device), the projector 108 and the 6-DOF sensor 114 located thereon. These sensors may include, for example, an inertial measuring unit (IMU), which may comprise one or more acceleration sensors, one or more gyroscopes, a magnetometer, and a pressure sensor. Other sensors are described in more detail hereinafter

The flight path of the UAV 112 may be predetermined prior to UAV flight and/or may be determined during UAV flight automatically in real time or near real time from the data gathered by the measuring system 124 located on board the UAV 112 and/or from the data gathered by the ground device, such as the laser tracker 10 or camera bar (FIG. 14). The flight path of the UAV 112 can be predetermined, for example, using the pre-designed CAD model of the object to be scanned (e.g., the aircraft 100 or the building 120). However the flight path is determined, the flight path of the UAV 112 may be preloaded into the flight control system of the UAV 112 or may be communicated to the UAV 112 by a ground device such as the laser tracker 10.

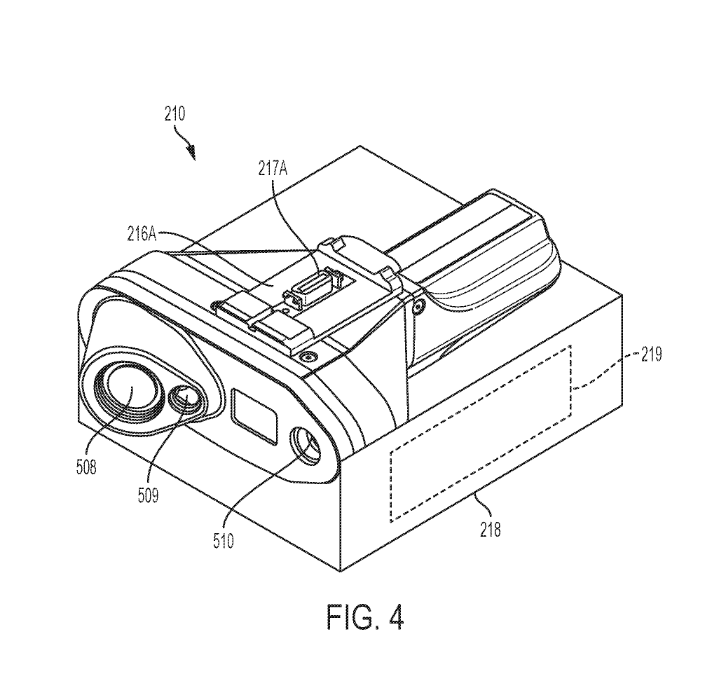

As mentioned, one example of an object measuring system or device 124 that may be located on board the UAV 112 is a triangulation scanner. Referring to FIG. 4, a triangulation scanner 210 located on the UAV 112 includes a camera 508 and at least one projector 510. In the exemplary embodiment, the projector 510 uses a light source that generates a straight line projected onto an object surface (e.g., the surface of the aircraft 100 in FIG. 2). The light source may be a laser, a superluminescent diode (SLD) or (SLED), an incandescent light, a light emitting diode (LED), for example. The projected light may be visible or invisible, but visible light may be more convenient in some cases. The camera 508 includes a lens and an imaging sensor. The imaging sensor is a photosensitive array that may be a charge-coupled device (CCD) 2D area sensor or a complementary metal-oxide-semiconductor (CMOS) 2D area sensor, for example, or it may be some other type of device. Each imaging sensor may comprise a 2D array (i.e., rows, columns) of a plurality of light sensing picture elements (pixels). Each pixel typically contains at least one photodetector that converts light into an electric charge stored within the pixel wells and read out as a voltage value. Voltage values are converted into digital values by an analog-to-digital converter (ADC). Typically for a CMOS sensor chip, the ADC is contained within the sensor chip. Typically for a CCD sensor chip, the ADC is included outside the sensor chip on a circuit board.

The projector 510 and camera 508 are electrically coupled to an electrical circuit 219 disposed within the enclosure 218. The electrical circuit 219 may include one or more microprocessors, digital signal processors, memory, and other types of signal conditioning and/or storage circuits.

The marker light source 509 emits a beam of light that intersects the beam of light from the projector 510. The position at which the two beams intersect provides an indication to the user of a desirable distance from the scanner 500 to the object under test (e.g., the aircraft 100 of FIG. 2 or the building 120 of FIG. 3). Alternatively, the triangulation scanner 210 may include two projectors, the first one being the projector 510 discussed herein which may be used to project invisible light for object surface measurement purposes while the second projector (not shown) may be used to project visible light in the form of information onto an object surface (e.g., the aircraft 100 of FIG. 2 or the building 120 of FIG. 3), as discussed in more detail herein. The use of two projectors within the triangulation scanner 210 may result in an increase in measurement speed while also allowing for relatively accurate projection of information.

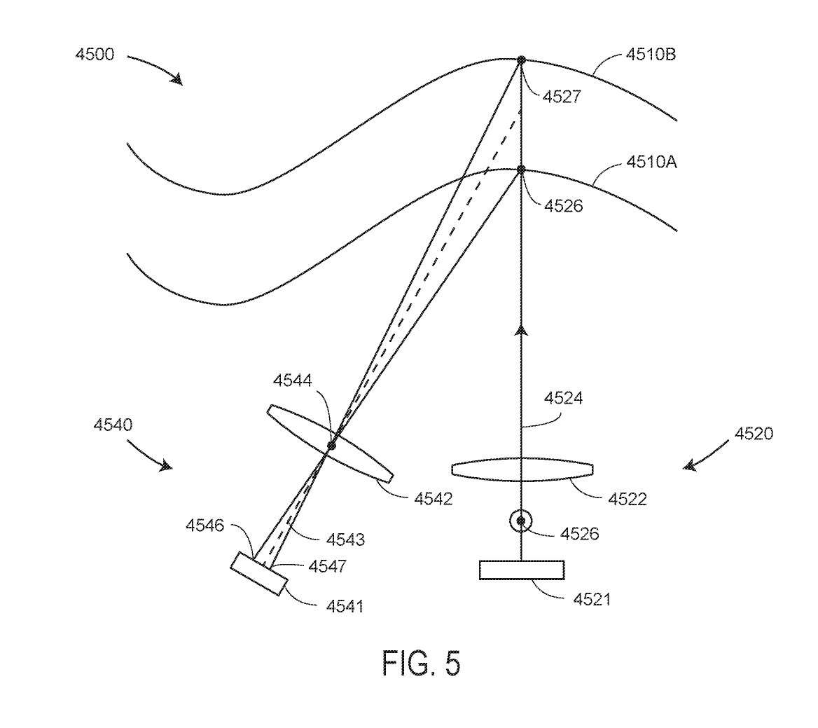

Another example of a measuring system or device 124 that may located on board the UAV 112 is a line scanner—more particularly, a laser line probe (LLP). FIG. 5 illustrates elements of a LLP 4500 located on the UAV 112 that includes a projector 4520 and a camera 4540. The projector 4520 includes a source pattern of light 4521 and a projector lens 4522. The source pattern of light includes an illuminated pattern in the form of a line. The projector lens includes a projector perspective center and a projector optical axis that passes through the projector perspective center. In the example of FIG. 5, a central ray of the beam of light 4524 is aligned with the projector optical axis. The camera 4540 includes a camera lens 4542 and a photosensitive array 4541. The lens has a camera optical axis 4543 that passes through a camera lens perspective center 4544. In the exemplary system 4500, the projector optical axis, which is aligned to the beam of light 4524 and the camera lens optical axis 4543, are perpendicular to the line of light 4523 projected by the source pattern of light 4521. In other words, the line 4523 is in the direction perpendicular to the paper in FIG. 5. The line strikes an object surface (e.g. the aircraft 100 of FIG. 2 or the building 120 of FIG. 3), which at a first distance from the projector is object surface 4510A and at a second distance from the projector is object surface 4510B. It is understood that at different heights above or below the plane of the paper of FIG. 5, the object surface may be at a different distance from the projector. The line of light intersects surface 4510A (in the plane of the paper) in a point 4526, and it intersects the surface 4510B (in the plane of the paper) in a point 4527. For the case of the intersection point 4526, a ray of light travels from the point 4526 through the camera lens perspective center 4544 to intersect the photosensitive array 4541 in an image point 4546. For the case of the intersection point 4527, a ray of light travels from the point 4527 through the camera lens perspective center to intersect the photosensitive array 4541 in an image point 4547. By noting the position of the intersection point relative to the position of the camera lens optical axis 4544, the distance from the projector (and camera) to the object surface can be determined using the principles of triangulation. The distance from the projector to other points on the line of light 4523, that is points on the line of light that do not lie in the plane of the paper of FIG. 5, may similarly be found.

In an embodiment, the photosensitive array 4541 is aligned to place either the array rows or columns in the direction of the reflected laser stripe. In this case, the position of a spot of light along one direction of the array provides information needed to determine a distance to the object (e.g., the aircraft 100 of FIG. 2 or the building 120 of FIG. 3), as indicated by the difference in the positions of the spots 4546 and 4547 of FIG. 5. The position of the spot of light in the orthogonal direction on the array provides information needed to determine where, along the length of the laser line, the plane of light intersects the object.

It should be understood that the terms column and row as used herein simply refer to a first direction along the photosensitive array and a second direction perpendicular to the first direction. As such, the terms row and column as used herein do not necessarily refer to row and columns according to documentation provided by a manufacturer of the photosensitive array 4541. In the discussion that follows, the rows are taken to be in the plane of the paper on the surface of the photosensitive array. The columns are taken to be on the surface of the photosensitive array and orthogonal to the rows. However, other arrangements are possible.

As explained hereinabove, light from a scanner may be projected in a line pattern to collect 3D coordinates over a line. Alternatively, light from a scanner may be projected to cover an area, thereby obtaining 3D coordinates over an area on an object surface (e.g., the aircraft 100 of FIG. 2 or the building 120 of FIG. 3). Thus, in an embodiment, the projector 510 in FIG. 4 is an area projector rather than a line projector. The position and orientation of the LLP or area scanner relative to an object may be determined by registering multiple scans together based on commonly observed features.

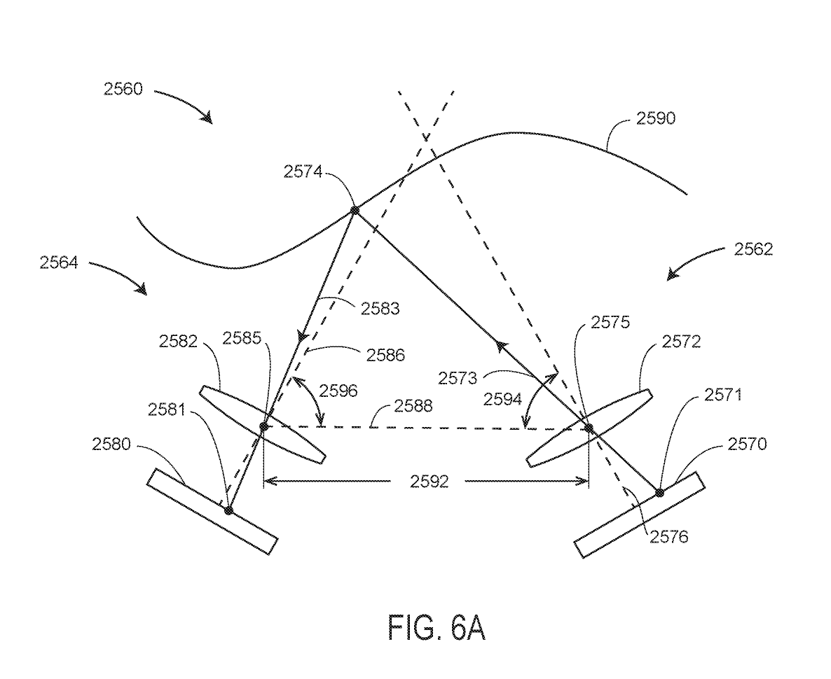

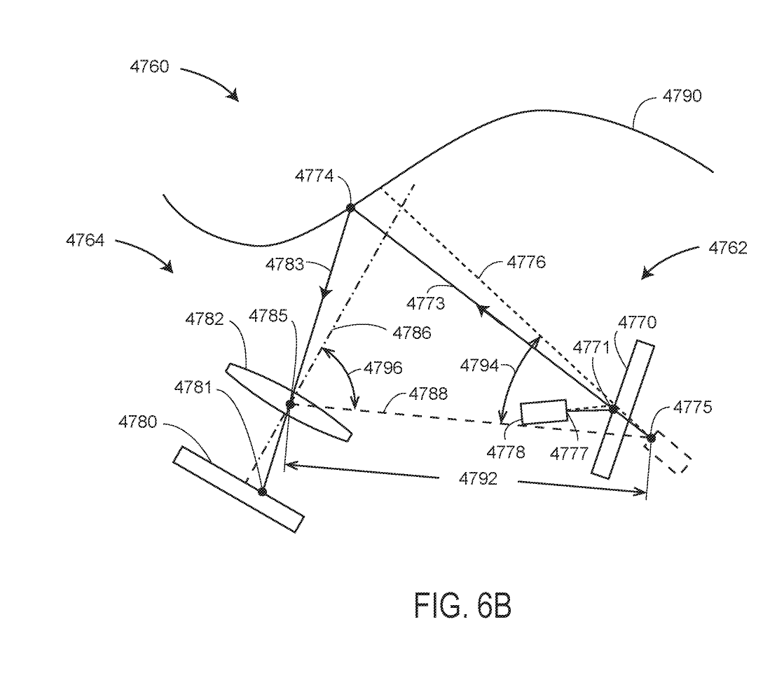

An explanation of triangulation principles for the case of area projection is now given with reference to the system 2560 of FIG. 6A and the system 4760 of FIG. 6B. Either system 2560 or 4760 may be mounted on the UAV 112 according to embodiments of the present invention. Referring first to FIG. 6A, the system 2560 includes a projector 2562 and a camera 2564. The projector 2562 includes a source pattern of light 2570 lying on a source plane and a projector lens 2572. The projector lens may include several lens elements. The projector lens has a lens perspective center 2575 and a projector optical axis 2576. The ray of light 2573 travels from a point 2571 on the source pattern of light through the lens perspective center onto the object 2590 (e.g., the aircraft 100 of FIG. 2 or the building 120 of FIG. 3), which it intercepts at a point 2574.

The camera 2564 includes a camera lens 2582 and a photosensitive array 2580. The camera lens 2582 has a lens perspective center 2585 and an optical axis 2586. A ray of light 2583 travels from the object point 2574 through the camera perspective center 2585 and intercepts the photosensitive array 2580 at point 2581.

The line segment that connects the perspective centers is the baseline 2588 in FIG. 6A and the baseline 4788 in FIG. 6B. The length of the baseline is called the baseline length 2592, 4792. The angle between the projector optical axis and the baseline is the baseline projector angle 2594, 4794. The angle between the camera optical axis 2583, 4786 and the baseline is the baseline camera angle 2596, 4796. If a point on the source pattern of light 2571, 4771 is known to correspond to a point on the photosensitive array 2581, 4781, then it is possible using the baseline length, baseline projector angle, and baseline camera angle to determine the sides of the triangle connecting the points 2585, 2574, and 2575, and hence determine the surface coordinates of points on the surface of object 2590 relative to the frame of reference of the measurement system 2560. To do this, the angles of the sides of the small triangle between the projector lens 2572 and the source pattern of light 2570 are found using the known distance between the lens 2572 and plane 2570 and the distance between the point 2571 and the intersection of the optical axis 2576 with the plane 2570. These small angles are added or subtracted from the larger angles 2596 and 2594 as appropriate to obtain the desired angles of the triangle. It will be clear to one of ordinary skill in the art that equivalent mathematical methods can be used to find the lengths of the sides of the triangle 2574-2585-2575 or that other related triangles may be used to obtain the desired coordinates of the surface of object 2590.

Referring first to FIG. 6B, the system 4760 is similar to the system 2560 of FIG. 6A except that the system 4760 does not include a lens. The system may include a projector 4762 and a camera 4764. In the embodiment illustrated in FIG. 6B, the projector includes a light source 4778 and a light modulator 4770. The light source 4778 may be a laser light source since such a light source may remain in focus for a long distance using the geometry of FIG. 6B. A ray of light 4773 from the light source 4778 strikes the optical modulator 4770 at a point 4771. Other rays of light from the light source 4778 strike the optical modulator at other positions on the modulator surface. In an embodiment, the optical modulator 4770 changes the power of the emitted light, in most cases by decreasing the optical power to a degree. In this way, the optical modulator imparts an optical pattern to the light, referred to here as the source pattern of light, which is at the surface of the optical modulator 4770. The optical modulator 4770 may be a DLP or LCOS device for example. In some embodiments, the modulator 4770 is transmissive rather than reflective. The light emerging from the optical modulator 4770 appears to emerge from a virtual light perspective center 4775. The ray of light appears to emerge from the virtual light perspective center 4775, pass through the point 4771, and travel to the point 4774 at the surface of object 4790 (e.g., the aircraft 100 of FIG. 2 or the building 120 of FIG. 3).

The baseline is the line segment extending from the camera lens perspective center 4785 to the virtual light perspective center 4775. In general, the method of triangulation involves finding the lengths of the sides of a triangle, for example, the triangle having the vertex points 4774, 4785, and 4775. A way to do this is to find the length of the baseline, the angle between the baseline and the camera optical axis 4786, and the angle between the baseline and the projector reference axis 4776. To find the desired angle, additional smaller angles are found. For example, the small angle between the camera optical axis 4786 and the ray 4783 can be found by solving for the angle of the small triangle between the camera lens 4782 and the photosensitive array 4780 based on the distance from the lens to the photosensitive array and the distance of the pixel from the camera optical axis. The angle of the small triangle is then added to the angle between the baseline and the camera optical axis to find the desired angle. Similarly for the projector, the angle between the projector reference axis 4776 and the ray 4773 can be found by solving for the angle of the small triangle between these two lines based on the known distance of the light source 4777 and the surface of the optical modulation and the distance of the projector pixel at 4771 from the intersection of the reference axis 4776 with the surface of the optical modulator 4770. This angle is subtracted from the angle between the baseline and the projector reference axis to get the desired angle.

The camera 4764 includes a camera lens 4782 and a photosensitive array 4780. The camera lens 4782 has a camera lens perspective center 4785 and a camera optical axis 4786. The camera optical axis is an example of a camera reference axis. From a mathematical point of view, any axis that passes through the camera lens perspective center may equally easily be used in the triangulation calculations, but the camera optical axis, which is an axis of symmetry for the lens, is customarily selected. A ray of light 4783 travels from the object point 4774 through the camera perspective center 4785 and intercepts the photosensitive array 4780 at point 4781. Other equivalent mathematical methods may be used to solve for the lengths of the sides of a triangle 4774-4785-4775, as will be clear to one of ordinary skill in the art.

Although the triangulation method described herein is well known, some additional technical information is given hereinbelow for completeness. Each lens system has an entrance pupil and an exit pupil. The entrance pupil is the point from which the light appears to emerge, when considered from the point of view of first-order optics. The exit pupil is the point from which light appears to emerge in traveling from the lens system to the photosensitive array. For a multi-element lens system, the entrance pupil and exit pupil do not necessarily coincide, and the angles of rays with respect to the entrance pupil and exit pupil are not necessarily the same. However, the model can be simplified by considering the perspective center to be the entrance pupil of the lens and then adjusting the distance from the lens to the source or image plane so that rays continue to travel along straight lines to intercept the source or image plane. In this way, the simple and widely used model shown in FIG. 6A is obtained. It should be understood that this description provides a good first order approximation of the behavior of the light but that additional fine corrections can be made to account for lens aberrations that can cause the rays to be slightly displaced relative to positions calculated using the model of FIG. 6A. Although the baseline length, the baseline projector angle, and the baseline camera angle are generally used, it should be understood that saying that these quantities are required does not exclude the possibility that other similar but slightly different formulations may be applied without loss of generality in the description given herein.

In some cases, a scanner system may include two cameras in addition to a projector. In other cases, a triangulation system may be constructed using two cameras alone, wherein the cameras are configured to image points of light on an object or in an environment. For the case in which two cameras are used, whether with or without a projector, a triangulation may be performed between the camera images using a baseline between the two cameras. In this case, the triangulation may be understood with reference to FIG. 6A, with the projector 2562 replaced by a camera.

In some cases, different types of scan patterns may be advantageously combined to obtain better performance in less time. For example, in an embodiment, a fast measurement method uses a 2D coded pattern in which 3D coordinate data may be obtained in a single shot. In a method using coded patterns, different characters, different shapes, different thicknesses or sizes, or different colors, for example, may be used to provide distinctive elements, also known as coded elements or coded features. Such features may be used to enable the matching of the point 2571 to the point 2581. A coded feature on the source pattern of light 2570 may be identified on the photosensitive array 2580.

An advantage of using coded patterns is that 3D coordinates for object surface points can be quickly obtained. However, in most cases, a sequential structured light approach, such as the sinusoidal phase-shift approach discussed above, will give more accurate results. Therefore, the user may advantageously choose to measure certain objects or certain object areas or features using different projection methods according to the accuracy desired. By using a programmable source pattern of light, such a selection may easily be made.

A line emitted by a laser line scanner intersects an object in a linear projection. The illuminated shape traced on the object is two dimensional. In contrast, a projector that projects a two-dimensional pattern of light creates an illuminated shape on the object that is three dimensional. One way to make the distinction between the laser line scanner and the structured light scanner is to define the structured light scanner as a type of scanner that contains at least three non-collinear pattern elements. For the case of a 2D coded pattern of light, the three non-collinear pattern elements are recognizable because of their codes, and since they are projected in two dimensions, the at least three pattern elements must be non-collinear. For the case of the periodic pattern, such as the sinusoidally repeating pattern, each sinusoidal period represents a plurality of pattern elements. Since there is a multiplicity of periodic patterns in two dimensions, the pattern elements must be non-collinear. In contrast, for the case of the laser line scanner that emits a line of light, all of the pattern elements lie on a straight line. Although the line has width, and the tail of the line cross section may have less optical power than the peak of the signal, these aspects of the line are not evaluated separately in finding surface coordinates of an object and therefore do not represent separate pattern elements. Although the line may contain multiple pattern elements, these pattern elements are collinear.

It should be noted that although the descriptions given above distinguish between line scanners and area (structured light) scanners based on whether three or more pattern elements are collinear, it should be noted that the intent of this criterion is to distinguish patterns projected as areas and as lines. Consequently patterns projected in a linear fashion having information only along a single path are still line patterns even though the one-dimensional pattern may be curved.

As mentioned, the six degrees of freedom (six-DOF) of a target measured by the laser tracker 10 may be considered to include three translational degrees of freedom and three orientational degrees of freedom. The three translational degrees of freedom may include a radial distance measurement, a first angular measurement, and a second angular measurement. The radial distance measurement may be made with an interferometer (IFM) in the tracker 10 or an absolute distance meter (ADM) in the tracker 10. The first angular measurement may be made with an azimuth angular measurement device, such as an azimuth angular encoder, and the second angular measurement made with a zenith angular measurement device, such as a zenith angular encoder. Alternatively, the first angular measurement device may be the zenith angular measurement device and the second angular measurement device may be the azimuth angular measurement device. The radial distance, first angular measurement, and second angular measurement constitute three coordinates in a spherical coordinate system, which can be transformed into three coordinates in a Cartesian coordinate system or another coordinate system.

The three orientational degrees of freedom may be determined using a patterned cube corner, as described in the aforementioned '758 patent. Alternatively, other methods of determining three orientational degrees of freedom may be used. The three translational degrees of freedom and the three orientational degrees of freedom fully define the position and orientation of a six-DOF target in physical space. It is important to note that this is the case for the systems considered here because it is possible to have systems in which the six degrees of freedom are not independent so that six degrees of freedom are not sufficient to fully define the position of a position and orientation in space. The term “translational set” is a shorthand notation for three degrees of translational freedom of a six-DOF accessory (such as a six-DOF scanner) in the tracker frame-of-reference (or device frame of reference). The term “orientational set” is a shorthand notation for three orientational degrees of freedom of a six-DOF accessory in a tracker frame of reference. The term “surface set” is a shorthand notation for three-dimensional coordinates of a point on the object surface in a device frame of reference.

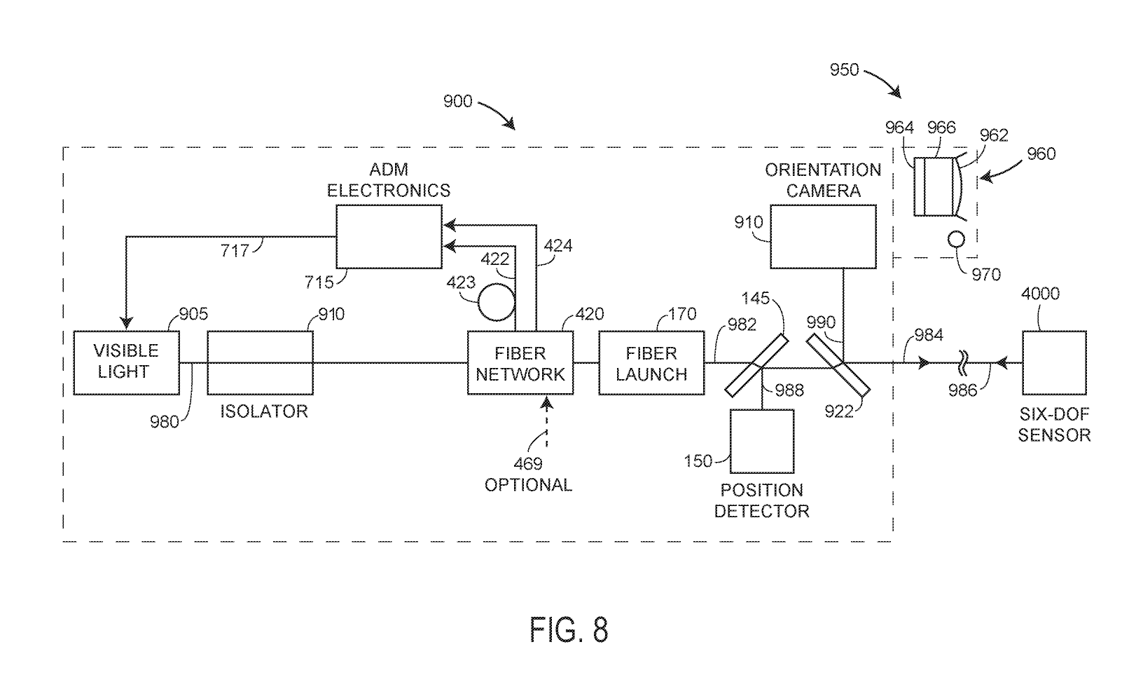

FIG. 7 illustrates an embodiment of a six-DOF scanner 2500 used with an optoelectronic system 900 and a locator camera system 950 which are both part of a laser tracker 10. The six-DOF scanner 2500 may also be referred to as a “target scanner” and may comprise the measuring system 124 located on the UAV 112. The optoelectronic system 900 and the locator camera system 950 are described in conjunction with FIG. 8.

FIG. 8 illustrates an embodiment of the locator camera system 950 and the optoelectronic system 900 in which an orientation camera 910 is combined with the optoelectronic functionality of a 3D laser tracker 10 to measure the six degrees of freedom of a target device such as one located on the UAV 112 in embodiments of the present invention. The optoelectronic system 900 of the laser tracker 10 includes a visible light source 905, an isolator 910, an optional electrooptic modulator 410, ADM electronics 715, a fiber network 420, a fiber launch 170, a beam splitter 145, a position detector 150, a beam splitter 922, and an orientation camera 910. The light from the visible light source is emitted in optical fiber 980 and travels through isolator 910, which may have optical fibers coupled on the input and output ports. The light may travel through the electrooptic modulator 410 modulated by an electrical signal 716 from the ADM electronics 715. Alternatively, the ADM electronics 715 may send an electrical signal over cable 717 to modulate the visible light source 905. Some of the light entering the fiber network travels through the fiber length equalizer 423 and the optical fiber 422 to enter the reference channel of the ADM electronics 715. An electrical signal 469 may optionally be applied to the fiber network 420 to provide a switching signal to a fiber optic switch within the fiber network 420. A part of the light travels from the fiber network to the fiber launch 170, which sends the light on the optical fiber into free space as light beam 982. A small amount of the light reflects off the beamsplitter 145 and is lost. A portion of the light passes through the beam splitter 145, through the beam splitter 922, and travels out of the tracker to six degree-of-freedom (DOF) device 4000. The six-DOF device 4000 may be a probe, a scanner, a projector, a sensor, or other type of device or target. In embodiments of the present invention, the six-DOF device 4000 is located on the UAV 112 (FIGS. 2, 3) and its position and orientation (i.e., its six-DOF) in physical space is determined by a laser tracker 10 or a camera bar.

On its return path, the light from the six-DOF device 4000 enters the optoelectronic system 900 and arrives at beamsplitter 922. Part of the light is reflected off the beamsplitter 922 and enters the orientation camera 910. The orientation camera 910 records the positions of some marks placed on the retroreflector target. From these marks, the orientation angle (i.e., three degrees of freedom) of the six-DOF probe is found. The principles of the orientation camera are described in the aforementioned '758 patent. A portion of the light at beam splitter 145 travels through the beamsplitter and is put onto an optical fiber by the fiber launch 170. The light travels to fiber network 420. Part of this light travels to optical fiber 424, from which it enters the measure channel of the ADM electronics 715.

The locator camera system 950 includes a camera 960 and one or more light sources 970. The locator camera system is also shown in FIG. 1 as part of the laser tracker 10, where the cameras are elements 52 and the light sources are elements 54. The camera includes a lens system 962, a photosensitive array 964, and a body 966. One use of the locator camera system 950 is to locate retroreflector targets in the work volume. It does this by flashing the light source 970, which the camera picks up as a bright spot on the photosensitive array 964. A second use of the locator camera system 950 is to establish a coarse orientation of the six-DOF device 4000 based on the observed location of a reflector spot or LED on the six-DOF device 4000. If two or more locator camera systems are available on the laser tracker 10, the direction to each retroreflector target in the work volume may be calculated using the principles of triangulation. If a single locator camera is located to pick up light reflected along the optical axis of the laser tracker, the direction to each retroreflector target may be found. If a single camera is located off the optical axis of the laser tracker 10, then approximate directions to the retroreflector targets may be immediately obtained from the image on the photosensitive array. In this case, a more accurate direction to a target may be found by rotating the mechanical axes of the laser to more than one direction and observing the change in the spot position on the photosensitive array.

In another embodiment, the optoelectronic system 900 may be replaced by an optoelectronic system that uses two or more wavelengths of light.

Referring back to FIG. 7, the six-DOF scanner 2500 which may be mounted on the UAV 112 includes a body 2514, one or more retroreflectors 2510, 2511, a scanner camera 2530, a scanner light projector 2520, an optional electrical cable 2546, an optional battery 2444, an interface component 2512, an identifier element 2549, actuator buttons 2516, an antenna 2548, and an electronics circuit board 2542. Although not shown in FIG. 7, the six-DOF scanner 2500 may include a second projector that may be similar to the second projector of the triangulation scanner 210 of FIG. 4 and used to project visible light information onto a surface of an object, as described in detail herein.

Electric power may be provided over the optional electrical cable 2546 or by the optional battery 2544. The electric power provides power to the electronics circuit board 2542. The electronics circuit board 2542 provides power to the antenna 2548, which may communicate with the laser tracker or an external computer, and to actuator buttons 2516, which provide the user with a convenient way of communicating with the laser tracker or external computer. The electronics circuit board 2542 may also provide power to an LED, a material temperature sensor (not shown), an air temperature sensor (not shown), an inertial sensor (not shown) or inclinometer (not shown). The interface component 2512 may be, for example, a light source (such as an LED), a small retroreflector, a region of reflective material, or a reference mark. The interface component 2152 is used to establish the coarse orientation of the retroreflectors 2510, 2511, which is needed in the calculations of the six-DOF angle. The identifier element 2549 is used to provide the laser tracker with parameters or a serial number for the six-DOF probe. The identifier element may be, for example, a bar code or an RF identification tag.

Together, the scanner projector 2520 and the scanner camera 2530 are used to measure the three dimensional coordinates of a surface of a workpiece 2528 (e.g., the aircraft 100 of FIG. 2 or the building 120 of FIG. 3). The camera 2530 includes a camera lens system 2532 and a photosensitive array 2534. The photosensitive array 2534 may be a CCD or CMOS array, for example. The scanner projector 2520 includes a projector lens system 2523 and a source pattern of light 2524. The source pattern of light may emit a point of light, a line of light, or a structured (two dimensional) pattern of light. If the scanner light source emits a point of light, the point may be scanned, for example, with a moving mirror, to produce a line or an array of lines. If the scanner light source emits a line of light, the line may be scanned, for example, with a moving mirror, to produce an array of lines. In an embodiment, the source pattern of light might be an LED, laser, or other light source reflected off a digital micromirror device (DMD) such as a digital light projector (DLP) from Texas Instruments, a liquid crystal device (LCD) or liquid crystal on silicon (LCOS) device, or it may be a similar device used in transmission mode rather than reflection mode. The source pattern of light might also be a slide pattern, for example, a chrome-on-glass slide, which might have a single pattern or multiple patterns, the slides moved in and out of position as needed. Additional retroreflectors, such as retroreflector 2511, may be added to the first retroreflector 2510 to enable the laser tracker 10 to track the six-DOF scanner 2500 from a variety of directions, thereby giving greater flexibility in the directions to which light may be projected by the projector 2520.

As mentioned, the 6-DOF scanner 2500 is mounted to or carried on the UAV 112 in various embodiments of the present invention. The 3D coordinates of a surface of the workpiece 2528 (e.g., the aircraft 100) is measured by the scanner camera 2530 using the principles of triangulation. There are several ways that the triangulation measurement may be implemented, depending on the pattern of light emitted by the scanner light source 2520 and the type of photosensitive array 2534. For example, if the pattern of light emitted by the scanner light source 2520 is a line of light or a point of light scanned into the shape of a line and if the photosensitive array 2534 is a 2D array, then one dimension of the 2D array 2534 corresponds to a direction of a point 2526 on the surface of the workpiece 2528. The other dimension of the 2D array 2534 corresponds to the distance of the point 2526 from the scanner light source 2520. Hence the 3D coordinates of each point 2526 along the line of light emitted by scanner light source 2520 is known relative to the local frame of reference of the 6-DOF scanner 2500. The six degrees of freedom of the 6-DOF scanner are known by the six-DOF laser tracker using the methods described in the aforementioned '758 patent. From the six degrees of freedom, the 3D coordinates of the scanned line of light may be found in the tracker frame of reference, which in turn may be converted into the frame of reference of the workpiece 2528 through the measurement by the laser tracker 10 of three points on the workpiece, for example.

A line of laser light emitted by the scanner light source 2520 may be moved in such a way as to “paint” the surface of the workpiece 2528, thereby obtaining the 3D coordinates for the entire surface. It is also possible to “paint” the surface of a workpiece using a scanner light source 2520 that emits a structured pattern of light. Alternatively, when using a scanner 2500 that emits a structured pattern of light, more accurate measurements may be made by hovering the UAV 112 in a relatively steady position. The structured light pattern emitted by the scanner light source 2520 might, for example, include a pattern of fringes, each fringe having an irradiance that varies sinusoidally over the surface of the workpiece 2528. In an embodiment, the sinusoids are shifted by three or more phase values. The amplitude level recorded by each pixel of the camera 2530 for each of the three or more phase values is used to provide the position of each pixel on the sinusoid. This information is used to help determine the three dimensional coordinates of each point 2526. In another embodiment, the structured light may be in the form of a coded pattern that may be evaluated to determine 3D coordinates based on single, rather than multiple, image frames collected by the camera 2530. Use of a coded pattern may enable relatively accurate measurements while the 6-DOF scanner 2500 is moved by hand at a reasonable speed.

Projecting a structured light pattern, as opposed to a line of light, has some advantages. In a line of light projected from a six-DOF scanner 2500, the density of points may be high along the line but much less between the lines. With a structured light pattern, the spacing of points is usually about the same in each of the two orthogonal directions. In addition, in some modes of operation, the 3D points calculated with a structured light pattern may be more accurate than other methods. For example, by holding the six-DOF scanner 2500 relatively steady, a sequence of structured light patterns may be emitted that enable a more accurate calculation than would be possible with other methods in which a single pattern was captured (i.e., a single-shot method). An example of a sequence of structured light patterns is one in which a pattern having a first spatial frequency is projected onto the object. In an embodiment, the projected pattern is a pattern of stripes that vary sinusoidally in optical power. In an embodiment, the phase of the sinusoidally varying pattern is shifted, thereby causing the stripes to shift to the side. For example, the pattern may be made to be projected with three phase angles, each shifted by 120 degrees relative to the previous pattern. This sequence of projections provides enough information to enable relatively accurate determination of the phase of each point of the pattern, independent of the background light. This can be done on a point by point basis without considering adjacent points on the object surface.

Although the procedure above determines a phase for each point with phases running from 0 to 360 degrees between two adjacent lines, there may still be a question about which line is which. A way to identify the lines is to repeat the sequence of phases, as described above, but using a sinusoidal pattern with a different spatial frequency (i.e., a different fringe pitch). In some cases, the same approach needs to be repeated for three or four different fringe pitches. The method of removing ambiguity using this method is well known in the art and is not discussed further here.

To obtain the best possible accuracy using a sequential projection method such as the sinusoidal phase-shift method described above, it may be advantageous to minimize the movement of the six-DOF scanner 2500. Although the position and orientation of the six-DOF scanner 2500 are known from the six-DOF measurements made by the laser tracker 10 and although corrections can be made for movements of the six-DOF scanner 2500, the resulting noise will be somewhat higher than it would have been if the scanner were kept stationary.

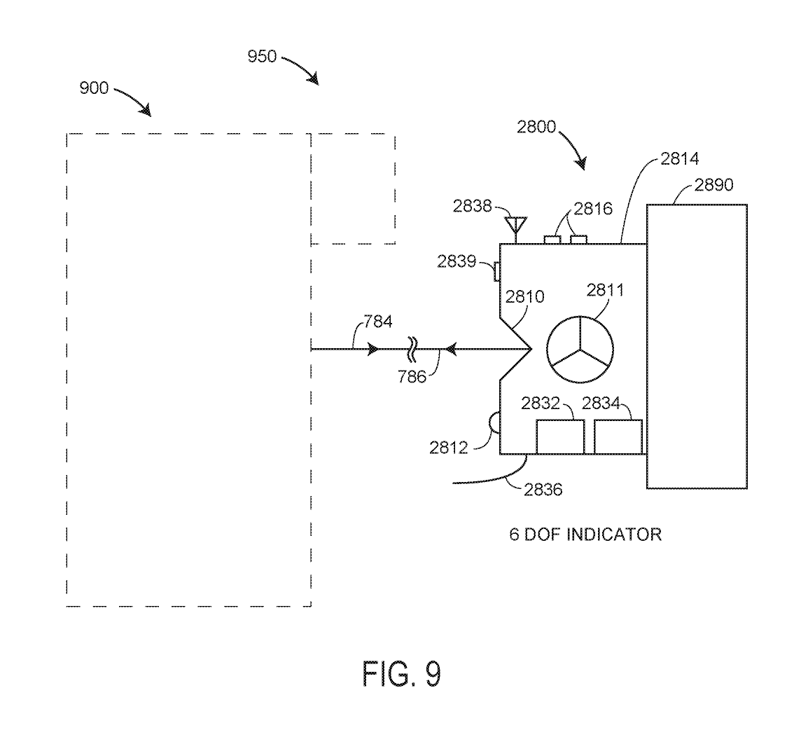

FIG. 9 shows an embodiment of a six-DOF indicator 2800 used in conjunction with the aforementioned optoelectronic system 900 and locator camera system 950 which are part of the laser tracker 10. The optoelectronic system 900 and the locator camera system 950 were described hereinabove with respect to FIG. 8. The six-DOF indicator 2800, which may be carried by the UAV 112, includes a body 2814, one or more retroreflectors 2810, 2811, a mount 2890, an optional electrical cable 2836, an optional battery 2834, an interface component 2812, an identifier element 2839, actuator buttons 2816, an antenna 2838, and an electronics circuit board 2832. The retroreflector 2810, the optional electrical cable 2836, the optional battery 2834, the interface component 2812, the identifier element 2839, the actuator buttons 2816, the antenna 2838, and the electronics circuit board 2832 illustrated in FIG. 9 correspond to the retroreflectors 2510, 2511, the optional electrical cable 2546, the optional battery 2544, the interface component 2512, the identifier element 2549, actuator buttons 2516, the antenna 2548, and the electronics circuit board 2542, respectively, illustrated in FIG. 7.

The mount 2890 may be attached to a moving element, for example, to the UAV 112, thereby enabling the laser tracker 10 to measure the six degrees of freedom (i.e., the position and orientation) of the moving element. The six-DOF indicator can be relatively compact in size because the retroreflector 2810 may be small and most other elements of FIG. 9 are optional and can be omitted. This relatively small size may provide an advantage in some cases. Additional retroreflectors, such as retroreflector 2811, may be added to the 6-DOF indicator 2800 to enable the laser tracker 10 to track the six-DOF indicator 2800 from a variety of directions.

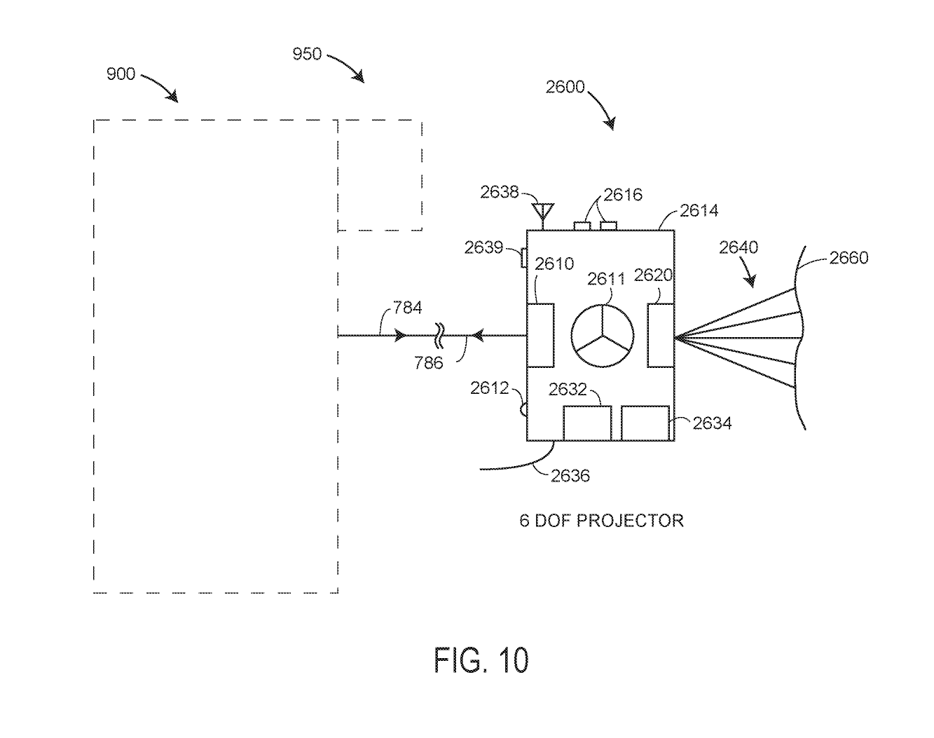

FIG. 10 shows an embodiment of a six-DOF projector 2600 used in conjunction with the aforementioned optoelectronic system 900 and locator camera system 950 which are part of the laser tracker 10. The optoelectronic system 900 and the locator camera system 950 were described hereinabove with respect to FIG. 8. In embodiments of the present invention, the six-DOF projector 2600 is carried by the UAV 112 and may be used to project information onto the surface of objects, such as the aircraft 100 of FIG. 2 and the building 120 of FIG. 3.

The six-DOF projector 2600 includes a body 2614, one or more retroreflectors 2610, 2611, a projector 2620, an optional electrical cable 2636, an optional battery 2634, an interface component 2612, an identifier element 2639, actuator buttons 2616, an antenna 2638, and an electronics circuit board 2632. The retroreflector 2610, the optional electrical cable 2636, the optional battery 2634, the interface component 2612, the identifier element 2639, the actuator buttons 2616, the antenna 2638, and the electronics circuit board 2632 illustrated in FIG. 10 correspond to the retroreflectors 2510, 2511, the optional electrical cable 2546, the optional battery 2544, the interface component 2512, the identifier element 2549, actuator buttons 2516, the antenna 2548, and the electronics circuit board 2542, respectively, illustrated in FIG. 7.

The six-DOF projector 2600 may include a light source, a light source and a steering mirror, a MEMS micromirror, a liquid crystal projector, or any other device capable of projecting a pattern of light onto a workpiece 2600. In various embodiments of the present invention, the projector 2600 may be used to project information onto the aircraft 100 as illustrated in FIG. 2 and on the building 120 as illustrated in FIG. 3.

The six degrees of freedom of the projector 2600 may be known by the laser tracker 10 using, for example, the methods described in the aforementioned '758 patent. From the six degrees of freedom, the 3D coordinates of the projected pattern of light 104 may be found in the tracker frame of reference, which in turn may be converted into the frame of reference of the workpiece through the measurement by the laser tracker of three points on the workpiece, for example. Additional retroreflectors, such as retroreflector 2611, may be added to the first retroreflector 2610 to enable the laser tracker 10 to track the six-DOF projector 2600 from a variety of directions, thereby giving greater flexibility in the directions to which light may be projected by the six-DOF projector 2600.

As discussed hereinabove in conjunction with FIGS. 2 and 3, with the projected information pattern of light 2640 on the surface of the workpiece 2660 known in the frame of reference of the workpiece, a variety of useful capabilities can be obtained. As a first example, the projected pattern of information may indicate where an operator should drill holes or perform other operations to enable the affixing of components onto the workpiece 2660. For example, gauges may be attached to the cockpit of an aircraft 100. Such a method of in-situ assembly can be cost effective in many cases. As another example, the projected pattern of information 104 may indicate where material needs to be added to or removed from the workpiece 2660 through the use of contour patterns, color coded tolerance patterns, or other graphical means. An operator may use a tool to abrade unwanted material or use a filler material to fill in an area. As the laser tracker 10 or an external computer 60 (FIG. 1) attached to the laser tracker may know the details of the CAD model, the six-DOF projector 2600 can provide a relatively fast and simple method for modifying the workpiece 2660 to meet CAD tolerances. Other assembly operations might include scribing, applying adhesive, applying a coating, applying a label, and cleaning. As yet another example, the projected pattern of information 104 may indicate hidden components on the workpiece 2660 which are not visible to the user. For example, tubing or electrical cables may be routed behind a surface and hidden from view. The location of these components may be projected onto the workpiece, thereby enabling the operator to avoid them in performing assembly or repair operations. Hence high levels of detail may be projected onto relatively large areas, enabling assistance to several operators simultaneously. It is also possible in a mode to enable the six-DOF scanner to project any of several alternative patterns of information onto the workpiece 2660, thereby enabling the operator to perform assembly operations in a prescribed sequence.

To project light from the projector 2600 into the frame of reference of the workpiece 2660, it is generally necessary to determine the frame of reference of the workpiece 2660 in the frame of reference of the laser tracker 10. One way to do this is to measure three points on the surface of the workpiece with the laser tracker. Then a CAD model or previously measured data may be used to establish a relationship between a workpiece and a laser tracker.

Besides assisting with assembly operations, the six-DOF projector 2600 can also assist in carrying out inspection procedures. In some cases, an inspection procedure may call for an operator to perform a sequence of measurements in a particular order. The six-DOF projector 2600 may point to the positions on the workpiece 2660 at which the operator is to make a measurement at each step in a sequence. The six-DOF projector 2600 may demarcate a region with projected information over which a measurement is to be made. For example, by drawing a box, the six-DOF projector 2600 may indicate that the operator is to perform a scanning measurement over the region inside the box, perhaps to determine the flatness of the regions or maybe as part of a longer measurement sequence. Because the projector 2600 can continue the sequence of steps while being tracked by the laser tracker 10, the operator may continue an inspection sequence using various tools. The six-DOF projector 2600 may also provide information to the operator on the workpiece 2660 in the form of written messages that may include audio messages. Also, the operator may signal commands to the laser tracker 10 using gestures that may be picked up by the tracker cameras or by other means.

The six-DOF projector 2600 may use patterns of light, perhaps applied dynamically to the workpiece 2660, to convey information. For example, the six-DOF projector 2600 may use a back and forth motion to indicate a direction to which an SMR or some other type of target is to be moved on the surface of the workpiece 2660. The six-DOF projector 2600 may draw other patterns to give messages that may be interpreted by an operator according to a set of rules, the rules which may be available to the user in written or displayed form.

The six-DOF projector 2600 may also be used to convey information to the user about the nature of an object under investigation. For example, if dimensional measurements have been performed, the six-DOF projector 2600 might project a color coded pattern indicating regions of error associated in the surface coordinates of the object under test (e.g., FIG. 2). Alternatively, it may display regions or values that are out of tolerance. The projector 2600 may, for example, highlight a region for which the surface profile is outside the tolerance using different colors to indicate different amounts of the workpiece 2660 being out of tolerance. Alternatively, the projector 2600 may draw a line to indicate a length measured between two points on the workpiece 2660 and then write a message on the workpiece 2660 indicating the amount of error associated with that distance.

The six-DOF projector 2600 may also display information about measured characteristics besides dimensional characteristics, wherein the characteristics are tied to coordinate positions on the object. Such characteristics of an object under test may include temperature values, ultrasound values, microwave values, millimeter-wave values, X-ray values, radiological values, chemical sensing values, and many other types of values. Such object characteristics may be measured and matched to 3D coordinates on an object using a six-DOF scanner. Here, characteristics of the object may be measured on the object using a separate measurement device, with the data correlated in some way to dimensional coordinates of the object surface with an object frame of reference. Then by matching the frame of reference of the object (e.g., the aircraft 100 of FIG. 2 or the building 120 of FIG. 3) to the frame of reference of the laser tracker 10 or the six-DOF projector 2600, information about the object characteristics may be displayed on the object, for example, in graphical form. For example, temperature values of an object surface may be measured using a thermal array. Each of the temperatures may be represented by a color code projected onto the object surface.

The six-DOF projector 2600 may also project modeled data onto an object surface. For example, it might project the results of a thermal finite element analysis (FEA) onto the object surface and then allow the operator to select which of two displays—FEA or measured thermal data—is displayed at any one time. Because both sets of data are projected onto the object at the actual positions where the characteristic is found—for example, the positions at which particular temperatures have been measured or predicted to exist, the user is provided with a clear and immediate understanding of the physical effects affecting the object.

In other embodiments, if a measurement of a small region has been made with features resolved that are too small for the human eye to see, the six-DOF projector 2600 may project a magnified view of those characteristics previously measured over a portion of the object surface onto the object surface, thereby enabling the user to see features too small to be seen without magnification. In an embodiment, the high resolution measurement may be made with a separate six-DOF scanner, and the results projected with the six-DOF projector 2600.

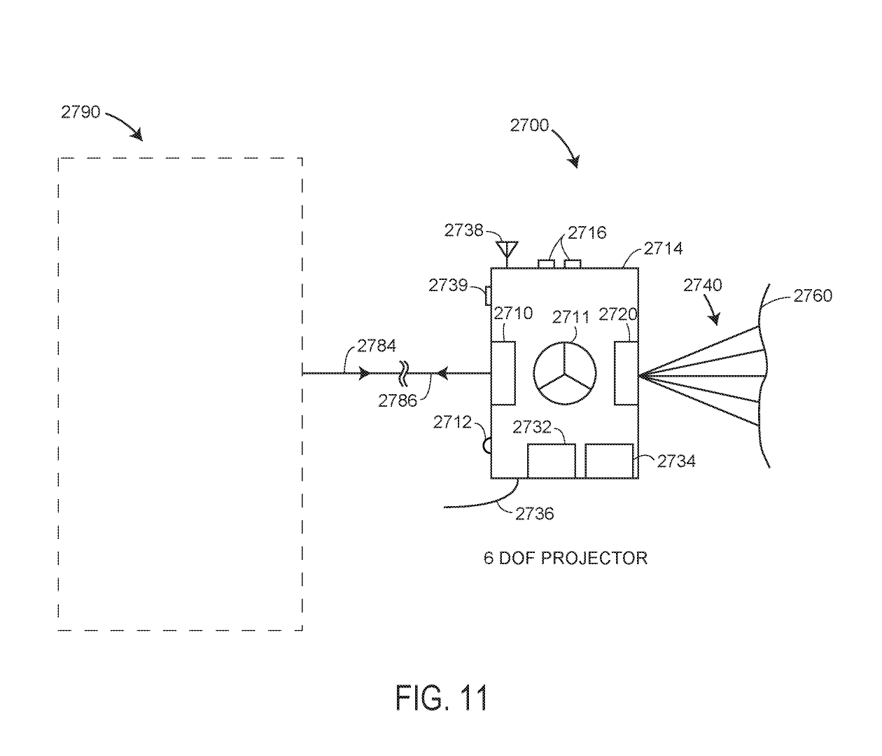

FIG. 11 illustrates an embodiment of a six-DOF projector 2700 used in conjunction with an optoelectronic system 2790. The optoelectronic system 2790 may be any device capable of measuring the six degrees of freedom of a six-DOF projector 2700, for example a laser tracker, a total station, a laser scanner, or a camera bar. In embodiments of the present invention, the six-DOF projector 2700 is carried by the UAV 112 and may be used to project information onto the surface of objects, such as the aircraft 100 of FIG. 2 or the building 120 of FIG. 3.

In an embodiment, the optoelectronic system 2790 contains one or more cameras that view illuminated light sources of retroreflectors on the six-DOF projector 2700. By noting the relative positions of the light source images on the one or more cameras, the three degrees of orientational freedom of the six-DOF projector 2700 are found. Three additional degrees of freedom are found (e.g., translational), for example, by using a distance meter and two angular encoders to find the three dimensional coordinates of the retroreflector 2710. In another embodiment, the three degrees of orientational freedom are found by sending a beam of light through a vertex of a cube corner retroreflector 2710 to a position detector, which might be a photosensitive array, to determine two degrees of freedom and by sending a polarized beam of light, which may be the same beam of light, through at least one polarizing beam splitter to determine a third degree of freedom. In yet another embodiment, the optoelectronic assembly 2790 sends a pattern of light onto the six-DOF projector 2700. In this embodiment, the interface component 2712 includes a plurality of linear position detectors, which may be linear photosensitive arrays, to detect the pattern and from this to determine the three degrees of orientational freedom of the six-DOF projector 2700. Many other optoelectronic systems 2790 are possible to determine the six degrees of freedom of the six-DOF projector 2700, as will be known to one of ordinary skill in the art.

The six-DOF projector 2700 includes a body 2714, one or more retroreflectors 2710, 2711, a projector 2720, an optional electrical cable 2736, an optional battery 2734, an interface component 2712, an identifier element 2739, actuator buttons 2716, an antenna 2738, and an electronics circuit board 2732. The optional electrical cable 2736, the optional battery 2734, the interface component 2712, the identifier element 2739, the actuator buttons 2716, the antenna 2738, and the electronics circuit board 2732 illustrated in FIG. 11 correspond to the retroreflector 2510, the optional electrical cable 2546, the optional battery 2544, the interface component 2512, the identifier element 2549, actuator buttons 2516, the antenna 2548, and the electronics circuit board 2542, respectively, illustrated in FIG. 7. Additional retroreflectors, such as retroreflector 2711, may be added to the first retroreflector 2710 to enable a laser tracker 10 or other six-DOF tracking device to track the six-DOF projector 2700 from a variety of directions, thereby giving greater flexibility in the directions to which light information may be projected by the six-DOF projector 2700.

Referring back to FIG. 7, note that for the case in which the scanner light source 2520 serves as a projector for displaying a pattern in addition to providing a light source for use in combination with the scanner camera 2530 (for determining the 3D coordinates of the workpiece), other methods for finding the six degrees of freedom of the target 2500 can be used.

FIGS. 10 and 11 are similar except that the six-DOF projector 2700 illustrated in FIG. 11 may use a wider range of six-DOF measurement methods than the six-DOF projector 2600 of FIG. 10. All of the discussion made about the applications for the six-DOF projector 2600 of FIG. 10 also applies to the six-DOF projector 2700 of FIG. 11.

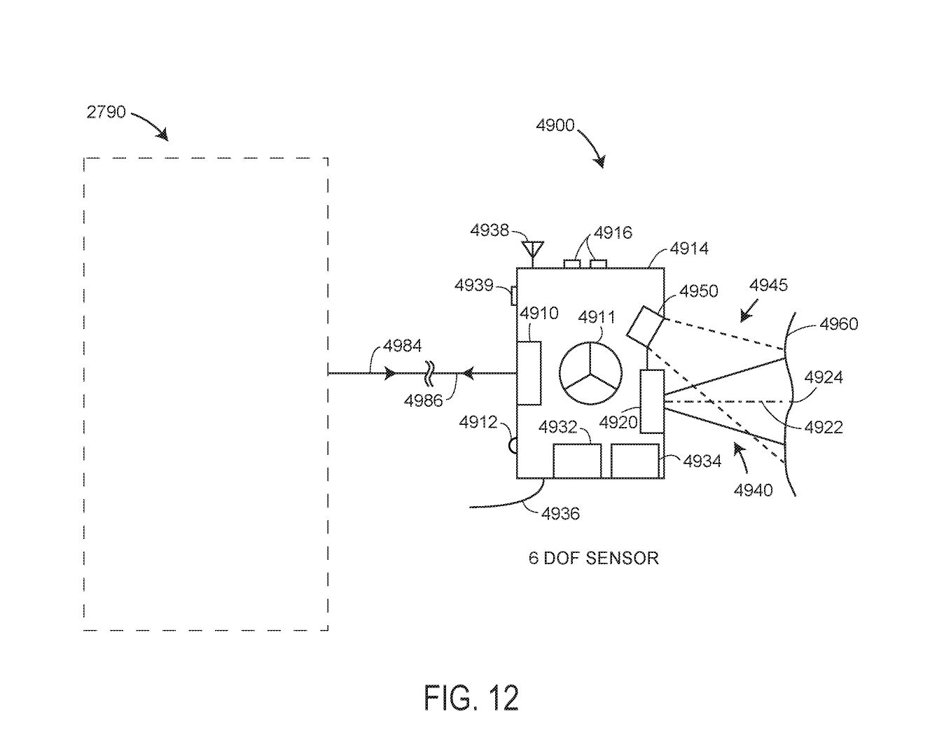

FIG. 12 illustrates an embodiment of a six-DOF sensor 4900 used in conjunction with an optoelectronic system 2790. The optoelectronic system 2790 may be any device capable of measuring the six degrees of freedom of the six-DOF sensor 4900, for example a laser tracker, a total station, a laser scanner, or a camera bar. In embodiments of the present invention, the six-DOF sensor 4900 may be mounted on or carried by the UAV 112. A projector separate from the sensor 4900 and located on the UAV 112, including any of the projectors 108 described hereinbefore, may be utilized to project information onto the surface of objects, such as the aircraft 100 of FIG. 2 and the building 120 of FIG. 3.

In an embodiment, the optoelectronic system 2790 contains one or more cameras that view illuminated light sources of retroreflectors on the six-DOF sensor 4900. By noting the relative positions of the light source images on the one or more cameras, the three degrees of orientational freedom of the six-DOF sensor 4900 are found. Three additional degrees of freedom are found (e.g., translational), for example, by using a distance meter and two angular encoders to find the three dimensional coordinates of the retroreflector 4910. In another embodiment, the three degrees of orientational freedom are found by sending a beam of light through a vertex of a cube corner retroreflector 4910 to a position detector, which might be a photosensitive array, to determine two degrees of freedom and by sending a polarized beam of light, which may be the same beam of light, through at least one polarizing beam splitter to determine a third degree of freedom. In yet another embodiment, the optoelectronic assembly 2790 sends a pattern of light onto the six-DOF sensor 4900. In this embodiment, the interface component 4912 includes a plurality of linear position detectors, which may be linear photosensitive arrays, to detect the pattern and from this to determine the three degrees of orientational freedom of the six-DOF sensor 4900. Many other optoelectronic systems 2790 are possible for determining the six degrees of freedom of the six-DOF sensor 4900, as will be known to one of ordinary skill in the art.

The six-DOF sensor 4900 includes a body 4914, one or more retroreflectors 4910, 4911, a sensor 4920, an optional source 4950, an optional electrical cable 4936, an optional battery 4934, an interface component 4912, an identifier element 4939, actuator buttons 4916, an antenna 4938, and an electronics circuit board 4932. The optional electrical cable 4936, the optional battery 4934, the interface component 4912, the identifier element 4939, the actuator buttons 4916, the antenna 4938, and the electronics circuit board 4932 illustrated in FIG. 12 correspond to the retroreflector 2510, the optional electrical cable 2546, the optional battery 2544, the interface component 2512, the identifier element 2549, actuator buttons 2516, the antenna 2548, and the electronics circuit board 2542, respectively, illustrated in FIG. 7. Additional retroreflectors, such as retroreflector 4911, may be added to the first retroreflector 4910 to enable the laser tracker 10 to track the six-DOF sensor 4900 from a variety of directions, thereby giving greater flexibility in the directions to which an object may be sensed by the six-DOF sensor 4900.

The sensor 4920 may be of a variety of types. For example, it may respond to optical energy in the infrared region of the spectrum, the light having wavelengths from 0.7 to 20 micrometers, thereby enabling determination of a temperature of an object surface at a point 4924 (e.g., the aircraft 100 of FIG. 2 or the building 120 of FIG. 3). The sensor 4920 is configured to collect infrared energy emitted by the object 4960 over a field of view 4940, which is generally centered about an axis 4922. The 3D coordinates of the point on the object surface corresponding to the measured surface temperature may be found by projecting the axis 4922 onto the object 4960 and finding the point of intersection 4924. To determine the point of intersection, the relationship between the object frame of reference and the device (tracker) frame of reference needs to be known. Alternatively, the relationship between the object frame of reference and the six-DOF sensor frame of reference may be known since the relationship between the tracker frame of reference and the sensor frame of reference is already known. Alternatively, the relationship between the object frame of reference and the six-DOF sensor frame of reference may be known since the relationship between the tracker frame of reference and the six-DOF sensor 4900 is already known from measurements performed by the tracker on the six-DOF sensor 4900. One way to determine the relationship between the object frame of reference and the tracker frame of reference is to measure the 3D coordinates of three points on the surface of the object. By having information about the object in relation to the three measured points, all points on the object of the surface will be known. Information on the object in relation to the three measured points may be obtained, for example, from CAD drawings or from previous measurements made by any type of coordinate measurement device.

Besides measuring emitted infrared energy, the electromagnetic spectrum may be measured (sensed) over a wide range of wavelengths, or equivalently frequencies. For example, electromagnetic energy may be in the optical region and may include visible, ultraviolet, infrared, and terahertz regions. Some characteristics, such as the thermal energy emitted by the object according to the temperature of the object, are inherent in the properties of the object and do not require external illumination. Other characteristics, such as the color of an object, depend on background illumination and the sensed results may change according to the characteristics of the illumination, for example, in the amount of optical power available in each of the wavelengths of the illumination. Measured optical characteristics may include optical power received by an optical detector, and may integrate the energy a variety of wavelengths to produce an electrical response according to the responsivity of the optical detector at each wavelength.

In some cases, the illumination may be intentionally applied to the object by a source 4950. If an experiment is being carried out in which it is desired that the applied illumination be distinguished from the background illumination, the applied light may be modulated, for example, by a sine wave or a square wave. A lock-in amplifier or similar method can then be used in conjunction with the optical detector in the sensor 4920 to extract just the applied light.

Other examples of the sensing of electromagnetic radiation by the sensor 4940 include the sensing of X-rays at wavelengths shorter than those present in ultraviolet light and the sensing of millimeter-wave, microwaves, RF wave, and so forth are examples of wavelengths longer than those present in terahertz waves and other optical waves. X-rays may be used to penetrate materials to obtain information about interior characteristics of object, for example, the presence of defects or the presence of more than one type of material. The source 4950 may be used to emit X-rays to illuminate the object 4960. By moving the six-DOF sensor 4900 and observing the presence of a defect or material interface of the object 4960 from a plurality of views, it is possible to determine the 3D coordinates of the defect or material interface within the material. Furthermore, if a sensor 4940 is combined with a projector such as the projector 2720 in FIGS. 10 and 11, a pattern of information comprising visible light may be projected onto an object surface that indicates where repair work needs to be carried out to repair the defect.

In an embodiment, the source 4950 provides electromagnetic energy in the electrical region of the spectrum—millimeter-wave, microwave, or RF wave. The waves from the source illuminate the object 4960, and the reflected or scattered waves are picked up by the sensor 4920. In an embodiment, the electrical waves are used to penetrate behind walls or other objects. For example, such a device might be used to detect the presence of RFID tags. In this way, the six-DOF sensor 4900 may be used to determine the position of RFID tags located throughout a factory. Other objects besides RFID tags may also be located. For example, a source of RF waves or microwaves such as a welding apparatus emitting high levels of broadband electromagnetic energy that is interfering with computers or other electrical devices may be located using a six-DOF scanner.

In an embodiment, the source 4950 provides ultrasonic waves and the sensor 4920 is an ultrasonic sensor. Ultrasonic sensors may have an advantage over optical sensors when sensing clear objects, liquid levels, or highly reflective or metallic surfaces. In a medical context, ultrasonic sensors may be used to localize the position of viewed features in relation to a patient's body. The sensor 4920 may be a chemical sensor configured to detect trace chemical constituents and provide a chemical signature for the detected chemical constituents. The sensor 4920 may be configured to sense the presence of radioactive decay, thereby indicating whether an object poses a risk for human exposure. The sensor 4920 may be configured to measure surface texture such as surface roughness, waviness, and lay. The sensor may be a profilometer, an interferometer, a confocal microscope, a capacitance meter, or similar device. A six-DOF scanner may also be used for measure surface texture. Other object characteristics can be measured using other types of sensors not mentioned hereinabove.

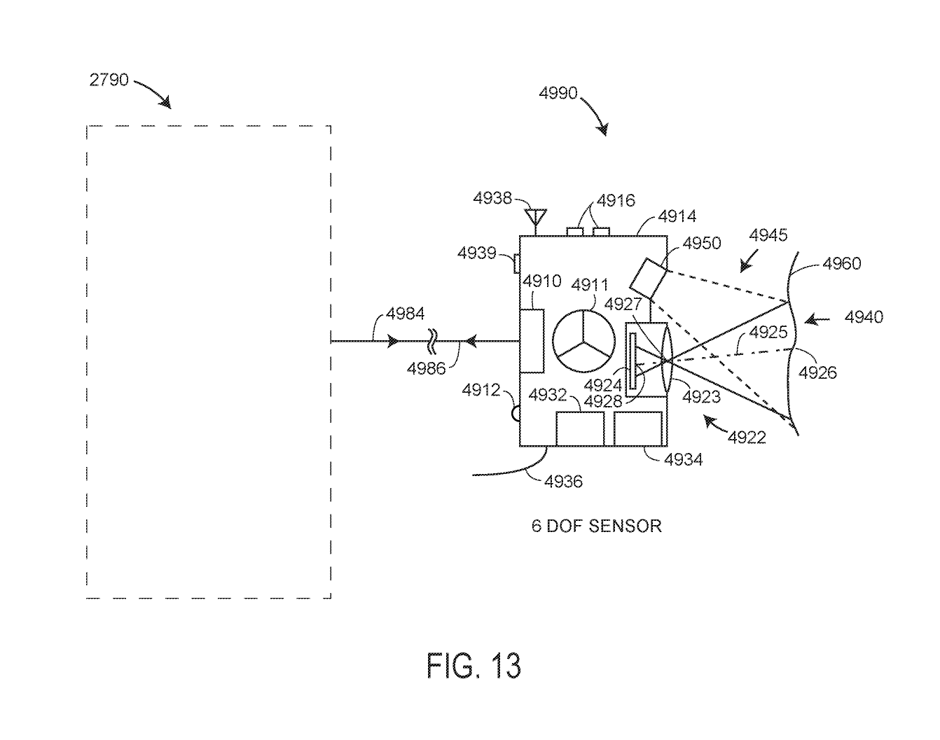

FIG. 13 shows an embodiment of a six-DOF sensor 4990 that is like the six-DOF sensor 4900 of FIG. 12 except that the sensor 4922 of the six-DOF sensor 4990 includes a lens 4923 and a photosensitive array 4924. The six-DOF sensor 4990 may be carried by the UAV 112 in embodiments of the present invention. An emitted or reflected ray of energy 4925 from within a field of view 4940 of the six-DOF sensor arises at a point 4926 on the object surface 4960, passes through a perspective center 4927 of sensor lens 4923 to arrive at a point 4928 on the photosensitive array 4924. A source 4950 may illuminate a region of the object surface 4960, thereby producing a response on the photosensitive array. Each point is associated with 3D coordinates of the sensed characteristic on the object surface, each 3D point determined by the three orientational degrees of freedom, the three translational degrees of freedom, the geometry of the camera and projector within the sensor assembly, and the position on the photosensitive array corresponding to the point on the object surface. An example of sensor 4922 is a thermal array sensor that responds by providing a temperature at a variety of pixels, each characteristic sensor value associated with a three-dimensional surface coordinate.

FIG. 14 is a perspective view of a three-dimensional measuring system 5200 that includes a camera bar 5110 and a six-DOF probe 5240. In embodiments of the present invention, the camera bar 5110 may be located on the ground and the six-DOF probe 5240 may be mounted on or carried by the UAV 112 (FIGS. 2 and 3). In embodiments of the present invention, the camera bar 5110 may be used in place of the laser tracker 10 illustrated in FIGS. 2 and 3 to measure the six degrees of freedom of a target device carried by the UAV 112, in the various manners as discussed hereinbefore.

The camera bar 5110 includes a mounting structure 5112 and at least two triangulation cameras 5120, 5124. In other embodiments, the mounting structure 5112 may be eliminated and cameras 5120, 5124 may be located where desired without being interconnected as in FIG. 14. It may also include an optional camera 5122. The cameras each include a lens and a photosensitive array. The optional camera 5122 may be similar to the cameras 5120, 5124 or it may be a color camera. The six-DOF probe 5140 includes a housing 5142, a collection of lights 5144, optional pedestals 5146, and shaft 5148. The lights 5144 may be light sources such as light emitting diodes or they might be reflective spots that may be illuminated by an external source of light. However, use of passive targets such as reflective spots or markers, or sphere targets, requires their illumination by an external light source. These embodiments may be relatively less reliable than use of active light sources 5144 because background light is not a reliable source of light and it also would be somewhat difficult to project a bright light source over a long distance to the UAV 112. Factory or on-site compensation procedures may be used to find these positions. The shaft 5148 may be used to mount the six-DOF probe 5240 to the UAV 112.

Triangulation of the image data collected by the cameras 5120, 5124 of the camera bar 5110 are used to find the 3D coordinates of each point of light 5144 within the frame of reference of the camera bar 5110. Herein, the term “frame of reference” is taken to be synonymous with the term “coordinate system.” Mathematical calculations, which are well known in the art, are used to find the position of the six-DOF probe 5240 within the frame of reference of the camera bar 5110.

An electrical system 5201 for the camera bar 5110 may include an electrical circuit board 5202 and an external computer 5204. The external computer 5204 may comprise a network of computers. The electrical system 5201 may include wired and wireless portions, either internal or external to the components of FIG. 14 that carry out the measurements and calculations required to obtain 3D coordinates of the six-DOF probe 5240. In general, the electrical system 5201 will include one or more processors, which may be computers, microprocessors, field programmable gate arrays (FPGAs), or digital signal processing (DSP) units, for example.

The six-DOF probe 5240 may also include a projector 5252 and a camera 5254. The projector 5252 projects light onto an object such as the aircraft 100 of FIG. 2 or the building 120 of FIG. 3. The projector 5252 may be a variety of types, for example, LED, laser, or other light source reflected off a digital micromirror device (DMD) such as a digital light projector (DLP) from Texas Instruments, a liquid crystal device (LCD), liquid crystal on silicon (LCOS) device, or a pico-projector from Microvision. The projected light might come from light sent through a slide pattern, for example, a chrome-on-glass slide, which might have a single pattern or multiple patterns, the slides moved in and out of position as needed. The projector 5252 may project light information 5262 into one or more areas 5266 on the object, as described in detail hereinbefore. A portion of the illuminated area 5266 may be imaged by the camera 5254 to obtain digital data indicative of the physical characteristics of the surface of the object.

The digital data may be partially processed using electrical circuitry within the scanner assembly 5240. The partially processed data may be provided to the system 5201 that includes the electrical circuit board 5202 and the external computer 5204. The result of the calculations is a set of coordinates in the camera bar frame of reference, which may in turn be converted into another frame of reference, if desired.

In an alternative embodiment, the projector 5252 may be a source of light that produces a stripe of light, for example, a laser that is sent through a cylinder lens or a Powell lens, or it may be a DLP or similar device also having the ability to project 2D patterns, as discussed hereinabove. The projector 5252 may project light 5262 in a stripe 5266 onto the object. A portion of the stripe pattern on the object may be imaged by the camera 5254 to obtain digital data. The digital data may be processed using the electrical components 5201.

While the invention has been described with reference to example embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A system for determining three-dimensional (3D) information regarding a surface of an object and projecting information onto the object surface or onto another surface, comprising:
an unmanned aerial vehicle configured to fly in physical space in a flight path that is under the control of a control device;
a scanning device located on the unmanned aerial vehicle, the scanning device configured to scan the object surface to measure two-dimensional (2D) or 3D coordinates thereof and to determine the 3D information of the object surface from the scanned 2D or 3D coordinates;
a projector located on the unmanned aerial vehicle, the projector configured to project the information in the form of visible light onto the object surface or onto the another surface; and
a position tracking device at least a portion of which is located apart from the unmanned aerial vehicle, the position tracking device being configured to comprise at least a portion of the control device to control the flight path of the unmanned aerial vehicle in physical space by sensing a position and orientation of the unmanned aerial vehicle in physical space and controlling the flight path in response to the sensed position and orientation of the unmanned aerial vehicle in physical space.

2. The system of claim 1, wherein the unmanned aerial vehicle is selected from the group consisting of a drone, a helicopter, a quadcopter, and an octocopter.

3. The system of claim 1, wherein the at least a portion of the position tracking device that is located apart from the unmanned aerial vehicle is located on or near the ground.

4. The system of claim 3, wherein the at least a portion of the position tracking device located on or near the ground is selected from the group consisting of a laser tracker and a camera bar.

5. The system of claim 4, wherein the laser tracker or camera bar is configured to measure six degrees of freedom of a device.

6. The system of claim 4, wherein at least another portion of the position tracking device that is not located on or near the ground is located as part of the unmanned aerial vehicle.

7. The system of claim 6, wherein the at least another portion of the position tracking device that is located as part of the unmanned aerial vehicle comprises a six degree of freedom (six-DOF) target.

8. The system of claim 7, wherein the six-DOF target is selected from the group consisting of a scanner, a projector, a probe, an indicator, a marker, a sphere, a retroreflector, a sensor, and one or more light sources.

9. The system of claim 7, wherein the laser tracker or camera bar is configured to measure six degrees of freedom of the six-DOF target.

10. The system of claim 9, wherein the control device is configured to control the flight path of the unmanned aerial vehicle in physical space by sensing the six degrees of freedom of the six-DOF target and controlling the flight path of the unmanned aerial vehicle in response to the sensed six degrees of freedom of the six-DOF target.

11. The system of claim 10, wherein the sensed six degrees of freedom of the six-DOF target include the position and orientation of the six-DOF target.

12. The system of claim 12, wherein the control device is configured to control the flight path of the unmanned aerial vehicle in physical space by sensing the position and orientation of the six-DOF target and controlling the flight path of the unmanned aerial vehicle by controlling the position and orientation of the unmanned aerial vehicle in response to the sensed position and orientation of the six-DOF target.

13. The system of claim 1, wherein the information projected by the projector comprises information relating to an aspect of the object surface.

14. The system of claim 13, wherein the aspect of the object surface comprises an amount of deviation between a desired value of at least one dimension of the object surface and an actual value of the at least one dimension of the object surface.

15. The system of claim 13, wherein the aspect of the object surface comprises an amount and/or type of work to be performed at a particular location on the object surface.

16. The system of claim 1, wherein the information projected by the projector comprises information relating to an aspect of the object surface which is communicated to the projector from a location apart from the unmanned aerial vehicle.

17. The system of claim 1, wherein the information projected by the projector comprises information relating to the determined 3D information of the object surface.

18. The system of claim 1, wherein the scanning device is selected from the group consisting of a triangulation scanner, a line scanner, a laser line probe, an area scanner, a pattern scanner, a structured light scanner, a time-of-flight scanner, a 2D camera, and a 3D camera.

19. The system of claim 1, wherein the unmanned aerial vehicle further includes one or more additional sensors carried by the unmanned aerial vehicle, wherein the one or more additional sensors are configured to determine the position and orientation of the unmanned aerial vehicle.

20. The system of claim 19, wherein the one or more additional sensors are selected from the group consisting of an inertial measuring unit, an acceleration sensor, a gyroscope, a magnetometer, and a pressure sensor.
